(19) United States
(12) Patent Application Publication
(10) Pub. No.: US 2010/0245286 A1
(43) Pub. Date: Sep. 30, 2010

(54) TOUCH SCREEN FINGER TRACKING ALGORITHM

(76) Inventor: Tabitha PARKER, Austin, TX (US)

Correspondence Address: HOWISON & ARNOTT, L.L.P, P.O. BOX 741715, DALLAS, TX, 75374-1715, US

(21) Appl. No.: 12/731,979

(22) Filed: Mar. 25, 2010

Related U.S. Application Data
(63) Continuation-in-part of application No. 12/650,724, filed on Dec. 31, 2009.
(60) Provisional application No. 61/163,353, filed on Mar. 25, 2009.

(51) Int. Cl. G06F 3/045

(52) U.S. Cl. 345/174

(57) ABSTRACT

A method is disclosed for tracking the paths of multiple objects across the surface of a capacitive touch screen using capacitive sensing of rows and columns therefore. The method includes first storing historical information for the coordinate location of a first object. Then, the potential coordinate location for both the first object and a second object at a current and given time are determined with a first determining step. A decision is then made with a second determining step as to which of the potential coordinate locations is associated with the first object at the given time based on the stored historical information.

### CROSS-REFERENCE TO RELATED APPLICATIONS

This application claims benefit from U.S. Provisional Application No. 61/163,353, filed Mar. 25, 2009, entitled TOUCH SCREEN FINGER TRACKING ALGORITHM (Atty. Dkt. No. CYGL-29,415), and is a Continuation-in-part of U.S. patent application Ser. No. 12/650,724, filed on Dec. 31, 2009, and entitled TOUCH SCREEN POWER-SAVING SCREEN SCANNING ALGORITHM (Atty. Dkt. No. CYGL-29,762); and is related to U.S. patent application Ser. No. 12/494,417, filed on Jun. 30, 2009, entitled SYSTEM AND METHOD FOR DETERMINING CAPACITANCE VALUE (Atty. Dkt. No. CYGL-29,111), U.S. patent application Ser. No. 12/146,349, filed on Jun. 25, 2008, entitled LCD CONTROLLER CHIP (Atty. Dkt. No. CYGL-28,970), co-pending U.S. patent application Ser. No. 12/651,152, filed Dec. 31, 2009, entitled SYSTEM AND METHOD FOR CONFIGURING CAPACITIVE SENSING SPEED (Atty. Dkt. No. CYGL-29,776), and co-pending U.S. patent application Ser. No. 12/650,748, filed Dec. 31, 2009, entitled CAPACITIVE SENSOR WITH VARIABLE CORNER FREQUENCY FILTER (Atty. Dkt. No. CYGL-29,799), all of which are incorporated herein by reference in their entirety.

### TECHNICAL FIELD

The present invention relates to an algorithm for tracking multiple finger touches on a capacitive array associated with a touch screen.

### BACKGROUND

Electronic circuit design often requires the use of various interface circuitries such as capacitive sensor arrays that enable the user to interact with or receive information from an electronic circuit. Typically, dedicated sensing circuitry may be used to detect the activation of various capacitive switches within a capacitive sensor array enabling a user to input particular information into a circuit.

Touch screen displays have X by Y capacitor arrays associated therewith. The capacitor arrays associated with the touch screen are used for detecting a touch or touches of an individual's fingers on the touch screen and providing this information for controlling various applications. Existing methods for sensing finger locations on a touch screen panel perform a scan of the entire panel in the full X and Y dimensions to create a map of the capacitances across the panel. This map is utilized to find finger locations within the touch screen.

With capacitive array touch screens, it is relatively straight forward matter to determine the general X and Y coordinate location of a single touch by determining that a change of capacitance has occurred at a particular row and column line. The intersection of those two lines represents the location of the touch. However, when multiple touches occur, this is a more difficult problem. The reason is that an ambiguity exists in that each touch will represent a capacitance change in a row and column line such that a capacitance change is detected upon two rows and upon two columns. It is difficult to know whether the first touch occurred in the first or the second column or the first or the second row. For simple capacitive array scanning methods wherein the change in capacitance of a particular row or a particular column is determined, it is difficult to resolve such ambiguities. Such techniques as Multi-Touch Resolve (MTR) have been developed which require the injection of a signal into a given row and the detection of the signal output at the column coupled thereto by the row-to-column capacitance. When this capacitance changes, the signal coupled thereacross will change. The MTR techniques require more complicated circuitry.

### SUMMARY

The present invention, as disclosed and described herein, in one aspect thereof, comprises a method for tracking the paths of multiple objects across the surface of a capacitive touch screen using capacitive sensing of rows and columns therefore. The method includes first storing historical information for the coordinate location of a first object. Then, the potential coordinate location for both the first object and a second object at a current and given time are determined with a first determining step. A decision is then made with a second determining step as to which of the potential coordinate locations is associated with the first object at the given time based on the stored historical information.

### BRIEF DESCRIPTION OF THE DRAWINGS

For a more complete understanding, reference is now made to the following description taken in conjunction with the accompanying Drawings in which:

FIG. 1A illustrates an overall diagram of a scan control IC interface with a touch screen;

FIG. 1B illustrates a more detailed diagram of the scan control IC;

FIG. 1C illustrates a more detailed diagram of the scan logic of the scan control IC;

FIG. 2 illustrates a diagrammatic view of the scan control IC interfaced with a touch screen and the port mapping functions;

FIG. 3 illustrates a diagrammatic view of the port mapping functions;

FIG. 4 is an upper level block diagram of one embodiment of an integrated circuit containing controller functionality coupled to the capacitive array of FIG. 1 via a multiplexer;

FIG. 5 is a functional block diagram of one embodiment of capacitive touch sense circuitry that may be used to detect capacitance changes in the capacitive array of FIG. 1;

FIG. 6 illustrates a block diagram of one embodiment of analog front end circuitry of the capacitive touch sense circuitry of FIG. 5;

FIG. 7 illustrates a diagrammatic view of the MTR module interfaced with a touch screen;

FIG. 8 illustrates a basic diagram for the ADC associated with the MTR function;

FIG. 8A illustrates a timing diagram for the MTR operation and the three phases thereof;

FIG. 9A illustrates the auto zero configuration for the ADC in the MTR;

FIG. 9B illustrates the transfer mode for the ADC in the MTR;

FIG. 9C illustrates the conversion phase for the ADC in the MTR;

FIG. 10 illustrates a detail of the SAR conversion operation;

FIG. 11 illustrates a block diagram for one method for scanning a capacitive array;

FIG. 12 illustrates a block diagram of an alternative method for scanning a capacitive array;

FIG. 13 illustrates a diagrammatic view of a touch screen illustrating two finger touches and the ghost images associated therewith when utilizing a self-capacitance scan;

FIG. 14 illustrates a diagrammatic view of the movement of two fingers across the touch screen;

FIGS. 15-22 illustrate diagrammatic views of the dual finger tracking algorithm;

FIG. 23 illustrates a flow chart for the dual finger tracking algorithm;

FIG. 24 illustrates a flow chart for the sub-routine utilized for the predicted portion for the dual finger tracking algorithm; and

FIG. 24A illustrates a diagrammatic view of predictive tracking.

### DETAILED DESCRIPTION

Referring now to the drawings, wherein like reference numbers are used herein to designate like elements throughout, the various views and embodiments of a touch screen scanning algorithm are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

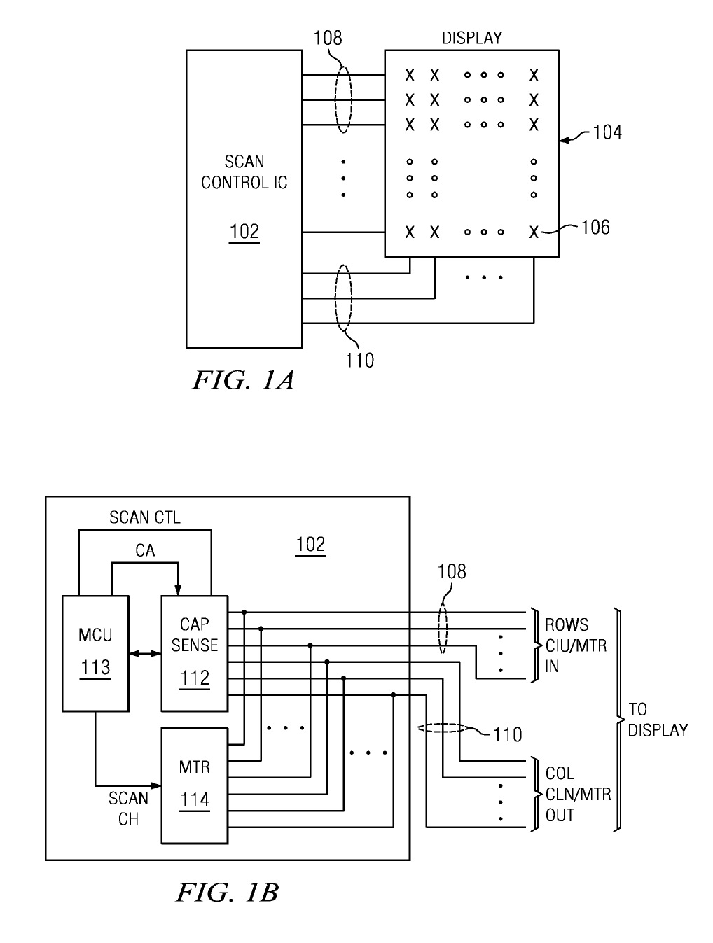

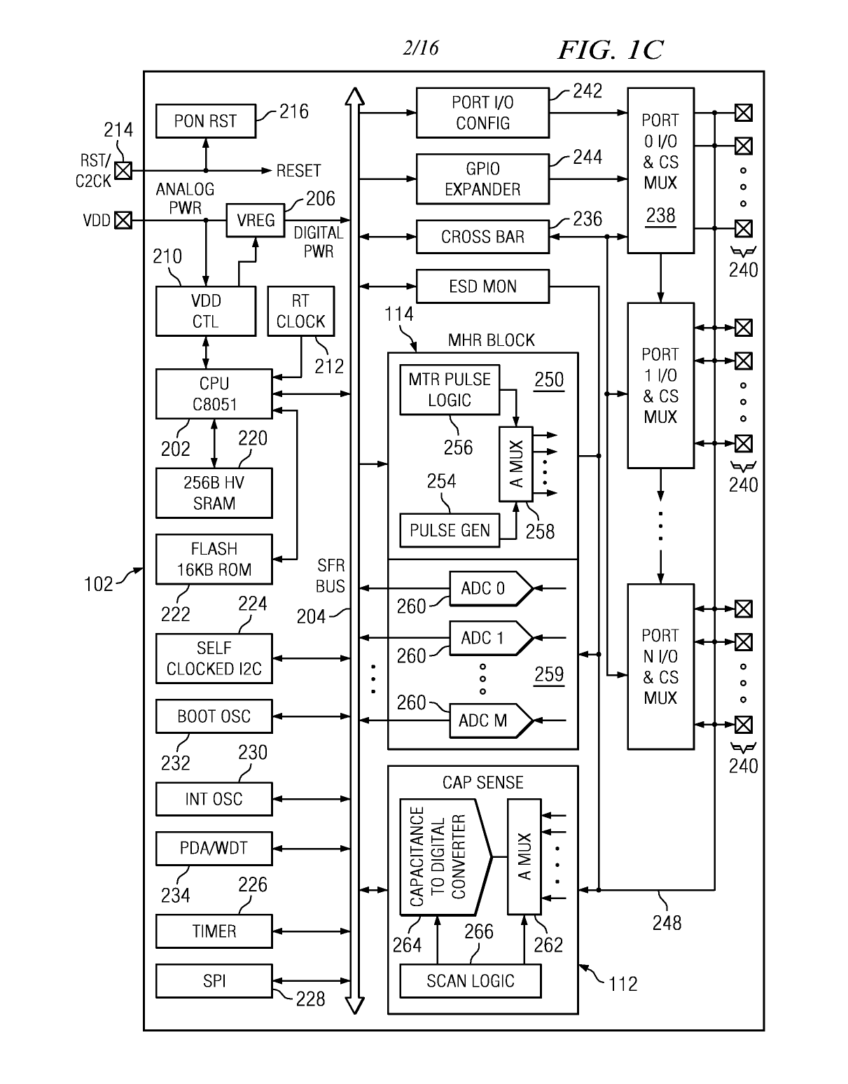

Referring now to FIG. 1A, there is illustrated a diagrammatic view of a scan control IC 102 that is interfaced with a touch screen 104 that can be used by itself or in conjunction with a display as an overlay. The touch screen 104 is a touch screen having a plurality of distributed capacitors 401 disposed at intersections of columns and rows. There are a plurality of rows 108 and a plurality of columns 110 interfaced with the scan control IC. Thus, a row line will be disposed across each row which intersects with a column line on the touch screen surface and these are interfaced with the scan control IC 102. It should be understood that a capacitive touch pad refers to an area on the touch screen, but will be used to refer to an intersection between a row line and a column line. The term “touch pad” and “intersection” shall be used interchangeably throughout.

As will be described hereinbelow, there are two methods for sensing a change in capacitance of the touch screen 104. The sensing can be based on self capacitance or mutual capacitance.

In self capacitance, each of the sensing points or pads 106 can be provided by an individually charged electrode. As an object approaches the surface of the touch screen 104, the object can capacitively couple to those electrodes in close proximity of the object, thereby stealing charge away from the electrodes. The amount of charge in each of the electrodes can be measured by the sensing circuit to determine the positions of objects as they touch the touch sensitive surface.

In mutual capacitance, the sensing device can typically include a two-layer grid of spatially separated wires. In the simplest case, the upper layer can include lines in rows, while the lower layer can include lines in columns (orthogonal). The sensing points or pads 106 can be provided at the intersections of the rows and columns. During operation, the rows can be charged and the charge can capacitively couple to the columns at the intersection. As an object approaches the surface of the touch device, the object can capacitively couple to the rows at the intersections in close proximity to the object, thereby stealing charge away from the rows and therefore the columns as well. The amount of charge in each of the row-to-column capacitors can be measured by the sensing circuit to determine the positions of multiple objects when they touch the touch sensitive surface.

Referring now to FIG. 1B, there is illustrated a more detailed diagrammatic view of the scan control IC 102. In determining a change in capacitance for a particular row or column line, either the self capacitance or mutual capacitance technique can be utilized. The first technique is to merely sense the value of the self capacitance for all or a select one or ones of the row or column lines and then utilize some type of algorithm to determine if the capacitance value has changed and then where that change occurred, i.e., at what intersection of row and column lines. The scan control IC 102 provides this functionality with a capacitive sense block 112. This block 112 determines if a change has occurred in the self capacitance value of the particular row or column line to ground. The second technique, the mutual capacitance technique, uses a “multi-touch resolve” (MTR) functionality provided by a functional block 114. This is for sensing changes in the mutual capacitance at the intersection of a row and column line. The cap sense block 112 is basically controlled to scan row and column lines and determine the self capacitance thereof to ground. If a change in the self capacitance occurs, this indicates that some external perturbance has occurred, such as a touch. By evaluating the self capacitance values of each of the rows and columns and comparing them with previously determined values, a determination can be made as to where on the touch screen a touch has been made. However, if multiple touches on the touch screen have occurred, this can create an ambiguity. The MTR module 114, as will be described in more detail herein below, operates to selectively generate a pulse or signal for output to each of the column lines and then monitor all the row lines to determine the size of the row-to-column capacitor based on the charge stored therein This provides a higher degree of accuracy in determining exactly which intersection of a particular row and column was touched. This is facilitated by applying a pulse on a particular column line, for example, which will cause charge to be transferred from the row-to-column capacitor to a sensing device. The sensing device will then determine the charge and also determine if there is a change therein, indicating a touch. The capacitance value for the row-to-column capacitor will decrease in the area where a finger is disposed across the particular intersection. It should be understood that the pulse could be generated on row lines and the column lines sensed, as opposed to the illustrated embodiment wherein the pulse is generated on the column lines and then the row lines sensed. It is noted that for each generation of a pulse, the row lines are monitored at substantially the same time. This could be facilitated with dedicated analog-to-digital converters for each row/column line or a multiplexed bank of such.

Referring now to FIG. 1C, there is illustrated a more detailed block diagram of the scan control IC 102. At the heart of the scan control IC 102 is an 8051 central processing unit (CPU) 202. The scan control IC 102 is basically a microcontroller unit (MCU) which is described in detail in U.S. Pat. No. 7,171,542, issued Jan. 30, 2007 to the present assignee and entitled RECONFIGURABLE INTERFACE FOR COUPLING FUNCTIONAL INPUT/OUTPUT BLOCKS TO LIMITED NUMBER OF I/O PINS, which is incorporated herein by reference in its entirety. This is a conventional MCU that utilizes an 8051 core processor, flash ROM and various configurable ports that are configured with a cross bar switch. The CPU 202 interfaces with a special function register (SFR) bus 204 to allow interface between the CPU domain and that of the internal resources. The CPU 202 is powered with a digital voltage that is provided by a regulator 206 that receives power from an external V_{DD} source to power the digital circuitry on the chip. Analog power is provided at the V_{DD} level which has a wider range, as this can sometimes be supplied by a battery. The regulator 206 is controlled with a V_{DD} controller 210. A real time clock 212 is provided to allow the CPU 202 to operate in a sleep mode with the clock 212 being activated. This is described in detail in U.S. Pat. No. 7,343,504, issued Mar. 11, 2008, entitled MICROCONTROLLER UNIT (MCU) WITH RTC, which is incorporated herein by reference in its entirety A RST/C2CK pin 214 provides a reset pulse and also provides a clock input to allow communication with the chip on a two-wire bus with a communication protocol requiring a clock and a data input. This is interfaced with a power on reset block 216 for the reset mode. The CPU 202 has SRAM 220 associated therewith and the overall chip has associated therewith a block of flash ROM 222 to allow for storage of instructions and configuration information and the such to control the overall operation of the chip and provide the user with the flexibility of programming different functionalities therefor.

There are a plurality of resources that are associated with the chip, such as an I²C two-wire serial bus functionality provided by a function block 224, timer functionality provided by block 226, a serial peripheral interface functionality provided by block 228, etc. These are described in detail in U.S. Pat. No. 7,171,542, which was incorporated herein by reference. There is provided a timing block 230 that provides the various clock functions that can be provided by internal oscillator, an external oscillator, etc. A boot oscillator 232 is provided for the boot operation and a PDA/WDT functionalities provided by block 234.

The SFR bus 204 is interfaced through various internal resources to a plurality of output pins. Although not described in detail herein, a cross bar switch 236 determines the configuration of the I/O pins to basically “map” resources onto these pins. However, this cross bar functionality has been illustrated as a simple block that interfaces with a plurality of port I/O blocks 238 labeled port 0, port 1 . . . port N. Select ones of these port I/O blocks 238 interface with a plurality of associated output pins 240 and each is operable to selectively function as a digital input/output port such that a digital value can drive the output pin or a digital value can be received therefrom. Alternatively, select ones of the output pins can be configured to be an analog pin to output an analog voltage thereto or receive an analog voltage therefrom. Each of the ports is configured with a port I/O configuration block 242 that configures a particular port and a particular output therefrom as either a digital I/O or as an analog port. A GPIO expander block 244 controls the operation of each of the ports. All of the output pins are illustrated as being connected to an analog bus 248. The configuration of the analog bus 248 illustrates this as a common single line but in actuality, this is a bus of multiple lines such that each individual port can be selectively input to a particular multiplexer or a particular analog input/output function block, as will be described herein below.

The MTR block 114 is illustrated as having associated therewith two functionalities, one functionality is provided by an upper block 250 and this provides the pulse logic for generating a pulse. This requires a pulse generator 254 and pulse scanning logic 256. An analog multiplexer 258 selectively outputs the pulse from the pulse generator 254 to a selectively mapped port through the analog bus 248. This is a representation only, as the CPU 202 actually selects an output port based on the configuration of an I/O port as an analog port and then enables such to be connected to the output of pulse generator 254. A lower functional block 259 of the MTR block 114 provides a plurality of analog-to-digital converters (ADCs) 260, each for interface with an associated one of the MTR-CDC in designated pins that represents an input from one of the column lines or one of the row lines, depending upon which is the sensed side of the MTR function. Even though a plurality of dedicated ADCs 260 are provided, it should be understood that a lower number of ADCs could be utilized and the function thereof multiplexed.

The cap sense function for the self capacitance sensing mode is provided by the block 112 and this is comprised of an analog multiplexer 262 which is interfaced to capacitance to digital converter 264 for selectively processing the selected column or row input received from the multiplexer 262. A scan logic block 266 provides the scanning control of the multiplexer 262. Thus, in one mode when the cap sense block 112 is utilized, the analog multiplexer 262 will select respective ones of the column and rows from the touch screen 104 for sensing the external capacitance thereon to determine if a change in the associated self capacitance has occurred. In a second mode, the MTR block 114 will be utilized to make a determination as to which of a row and a column line was actually touched in order to resolve any ambiguities when multiple touches on the screen occur. Further, it is possible to scan only a portion of the touch screen 104 in any one of the two modes.

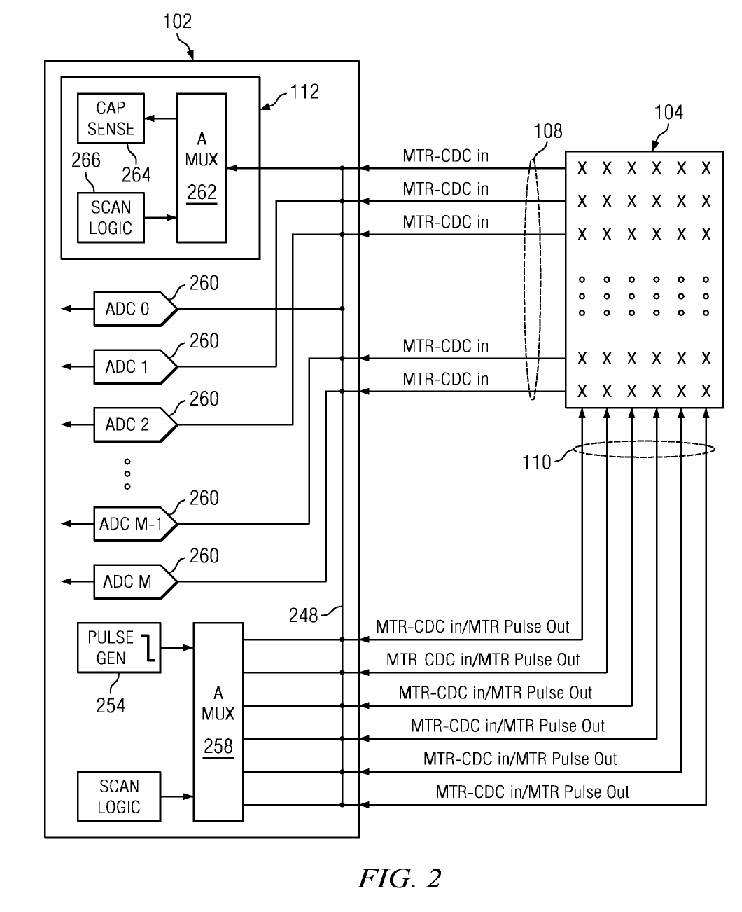

Referring now to FIG. 2, there is illustrated a diagrammatic view of the scan control chip 102 interfaced with the touch screen 104 showing only the analog interface between the scan control logic for self capacitance and mutual capacitance modes of operation. It can be seen that there are a plurality of pins that are associated with either the row lines 108 or the column lines 110. The analog line 248 (which was noted as being an analog bus) is interfaced with the cap sense block 112 via the multiplexer 262 to select each of the row and column lines in any combination for sensing the self capacitance associated therewith, or with the output of each of the ADCs 260 associated with each of the MTR CDC in inputs (for the rows in this example) to sense the analog value thereof. Alternatively, each of the column lines 110 in this embodiment can be accessed with the pulse generator 254 in the MTR mode via the analog line (bus) 248. (The MTR in lines will be a multi bit bus, wherein the MTR T_{X} out will be a single line with I/O enable selection.) Therefore, there will be two modes of operation, one being for the MTR mode wherein a pulse or any kind of signal is generated on a particular column (or row) and then sensed on each of the rows (or columns) to determine the mutual capacitance therebetween and a second mode to determine the self capacitance of each of the row or column lines. Therefore, since each of the pins that can be associated with the touch screen 104 has the ability to function as an analog port to the chip, an analog signal can be output therefrom or received thereon and interfaced with the respective one of the capacitive sense block 112 or the MTR block 114.

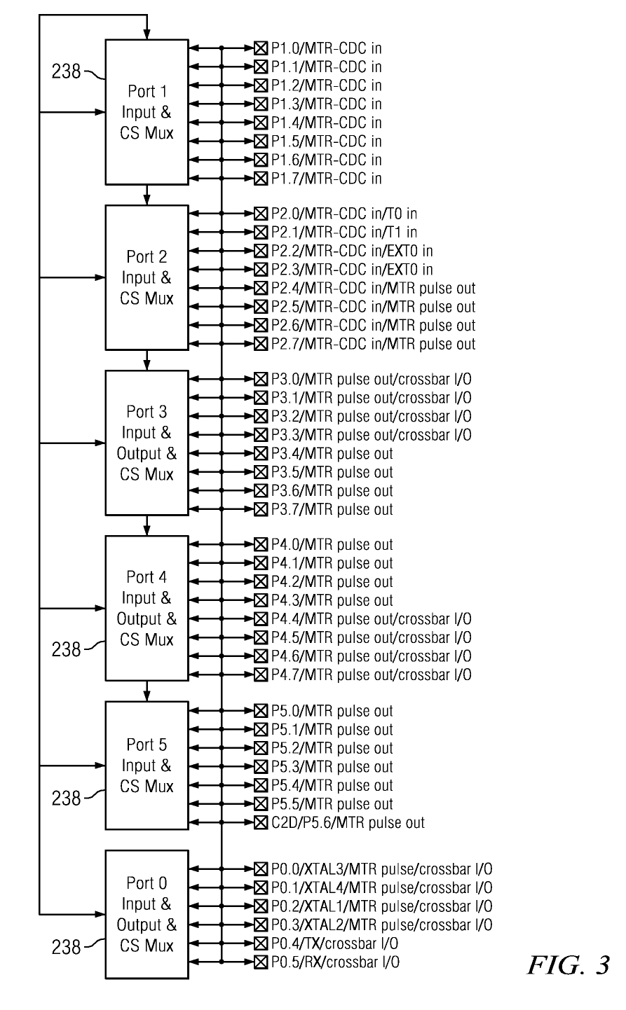

Referring now to FIG. 3, there is illustrated a detail of the port blocks 238 which illustrate the mapping thereto in one embodiment, this embodiment for scanning touch screens. There are illustrated six port blocks 238, which have the mapping defined typically by the cross bar switch and the analog connections. The cross bar is operable to define the digital interface between various functional blocks and the output pads 240. In this configuration, there are provided 31 MTR-CDC in pins (MTR R_{X}) and 16 MTR pulse out connections (MTR T_{X}). This provides for essentially 16 rows and 31 columns, it being noted that the pulse can be input to either the rows or the columns with the sensing being done respectively, on either the columns or rows. All of the pulse out connections are able to be sensed by the cap sense functionality. Thus, the MTR-CDC in constitute the rows and the MTR pulse out connections provide the columns for the touch screen. It can be seen that the block 238 for port 1 services the MTR-CDC in exclusively whereas all of the pins associated with port 2 provide the same functionality. In addition, some of the port 2 output pins have a GPIO function, two of them being timer inputs and two of them being ext0 inputs. Four of the output pins associated with port 2 are associated with both the input and the pulse out functions of the MTR. For port 3, it can be seen that four pins are mapped to the cross bar I/O for a digital functionality as well as four of the pins on port 4. Substantially all of the pins associated with port 5 are associated with the MTR pulse outputs. A number of the port 0 outputs are associated with a crystal functionality and two are associated with the transmit/receive functionality for a serial port interface and various ones are associated with the cross bar inputs/outputs. It should be understood that the crossbar switch can be configured to map the outputs of multiple functional blocks within the IC 102 (internal resources) to the input/output pins and the various analog outputs/inputs of the pins can be interfaced with the two functional blocks 112 and 114 for sensing the capacitive value of the touch screen.

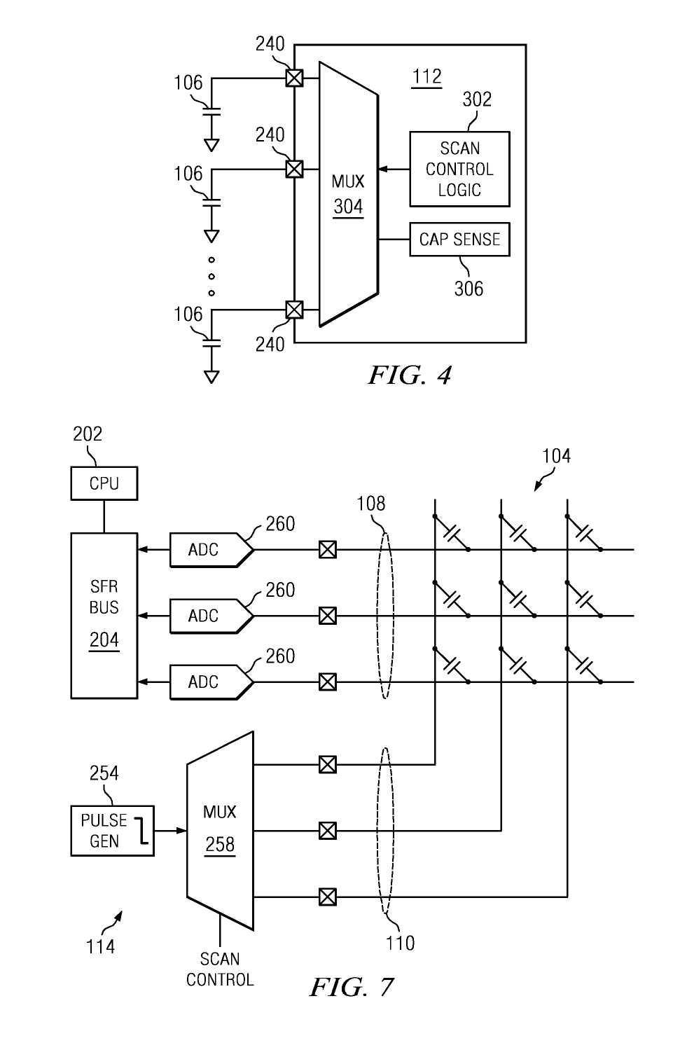

Referring now to FIG. 4, there is illustrated one embodiment of a block diagram of the cap sense block 112 of FIG. 1. In the present example, the interface between the block 112 and the row lines or column lines (FIG. 1) are illustrated and these are referred to, for simplicity purposes, as “capacitive touch pads.” More specifically, the block 112 interfaces with the plurality of row or column lines (noted in the drawing as capacitive touch pads 106) that are each interfaced with the block 112 through respective external row lines 108 or column lines 110. The touch pads 106 are typically arranged in rows and columns and the illustrated touch pad 106 represents the self capacitance of one or a plurality of row lines or column lines. The capacitive touch pads 106 can be stand alone elements or they can be part of a capacitive sensor array, such as the touch screen 104 previously described. Although not illustrated, the block 112 also interfaces with columns on dedicated column pins (not shown).

The block 112 includes a multiplexer 304 that is operable to select one of the pins 240 and one plate of an associated capacitive touch pad 106 (or row line) for input to a capacitive sense block 306 (capacitance-to-digital converter 264 of FIG. 1C). The capacitive sense block 306 is operable to determine the value of the self capacitance for the row line (column line) associated with the selected pin 240. This will then allow a determination to be made as to the value of the self capacitance, which will be referred to as the capacitance associated with an “external capacitance switch,” (or row of switches) this value being the sum of the value of the associated capacitive touch pad(s) 106 attached to a given pin 240 and any parasitic capacitance such as may result from a finger touch, external interference, etc. (In actuality, all that is attached to a pin 240 is a row or column line but, as set forth hereinabove, a touch screen array of row and column lines that overlap will be referred to as an array of “switches.”) The information as to the self capacitance value of the external capacitance switch is then passed on to the MCU 113 for the purpose of determining changes in the capacitance value as compared to previous values, etc., with the use of executable instructions and methods. The multiplexer 304 is controlled by scan control logic 302 to sequentially scan the pins 240 from a beginning pin 240 to an end pin 240. This can be programmable through an SFR or it can be hardwired in combinational logic. One example of an application of such is described in previously incorporated U.S. patent application Ser. No. 12/146,349, filed on Jun. 25, 2008, entitled “LCD CONTROLLER CHIP.”

In general, one application would be to individually sense the static value of the self capacitance of each of the row or column lines at each of the pins 240 at any given time and continually scan all or a portion of these row or column lines to determine if a change in self capacitance has occurred, i.e., whether the value of the self capacitance has changed by more than a certain delta. If so, with the use of a predetermined algorithm, a decision can be made as to whether this constitutes a finger touch or external interference. However, the capacitive sense block 112 is primarily operable to determine the self capacitance value of the row or column line connected to a pin 240 and then, possibly, provide some hardware control for accumulating the particular values and comparing them with prior values for generating an interrupt to the MCU 113. However, the first object of the capacitive sense block 112 is to determine the self capacitance value of the row or column line connected to a particular pin 240 being scanned at any particular time.

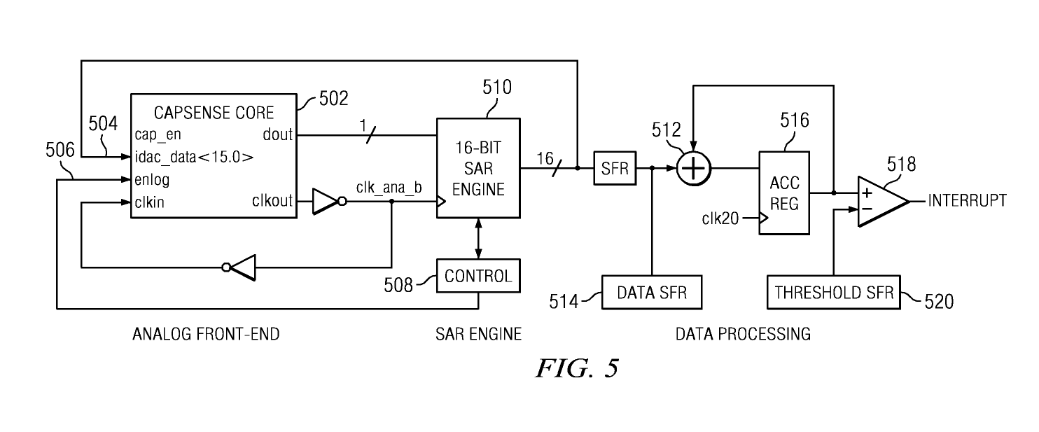

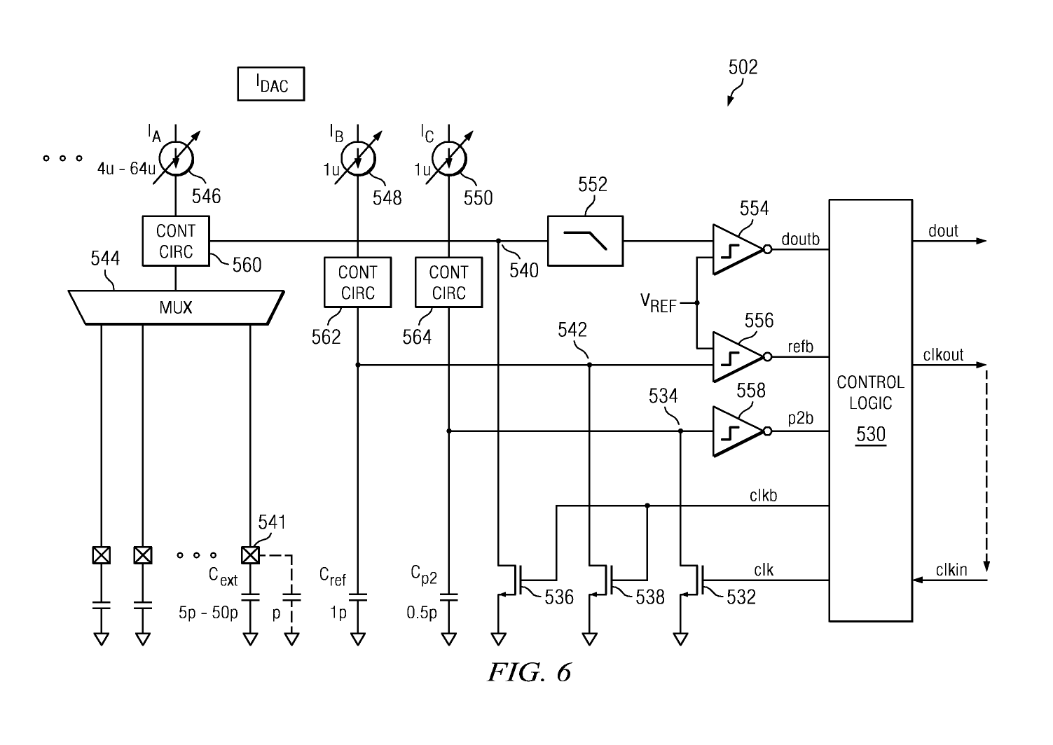

Referring now to FIGS. 5 and 6, one embodiment of a functional block diagram of the capacitive touch sense block 306 is illustrated. The analog front end circuitry 502 shown in FIG. 5 is responsible for a connected external capacitance switch (a row or column line) for the purpose of determining the value of the self capacitance thereof. The analog front end circuitry 502 receives a 16-bit current control value which is provided to the input IDAC_DATA via input 504 for controlling a variable current source. This current is generated by a current digital-to-analog converter (IDAC), not shown. The analog front end also receives an enable signal at the input ENLOG 506 from a control circuit 508. The analog front end circuitry 502 additionally provides a clock signal. A 16-bit successive approximation register (SAR) engine 510 controls a first variable current source within the analog front end circuitry 502 that drives the external capacitance switch. The 16-bit SAR engine 510 changes a control value which defines a present value of a variable current I_{A} that drives an external capacitor C_{EXT} (as seen in FIG. 6) on a selected one of the output pads 541. This selection is made by multiplexer 544, and the capacitor C_{EXT} corresponds to self capacitance of the respective row or column line in combination with any parasitic capacitance of the row or column line. The current source generating the current I_{A} that drives the selected external capacitor C_{EXT} from current source 546 will cause a voltage to be generated on that external capacitor C_{EXT} that is compared to the voltage across an internal reference capacitor C_{REF} (as shown in FIG. 5). This capacitor C_{REF} is an internal capacitor and the current provided thereto from an internal current source is a constant current for a given capacitance measurement. The currents I_{A} and I_{B} may be further configurable via respective current control circuitry 560 and 562 to vary the current (seen in FIG. 6).

Both capacitors, the selected capacitor C_{EXT} and the reference capacitor C_{REF}, are initialized at a predetermined point and the currents driven thereto allow the voltages on the capacitors C_{EXT} and C_{REF} to ramp-up at the rate determined by the respective capacitance value and the current provided by the respective current sources and current control circuitry that provide driving current thereto. By comparing the ramp voltages and the ramp rates, a relative value of the two currents can be determined. This is facilitated by setting a digital value to the IDAC and determining if the ramp rates are substantially equal. If the capacitors C_{EXT} and C_{REF} were identical, then the two ramp rates would be substantially identical when the current driving capacitors C_{EXT} and C_{REF} are substantially identical. If the capacitor C_{EXT} is larger, this would require more current to derive a ramp rate that is substantially identical to the capacitor C_{REF}. Once the SAR algorithm is complete, the 16-bit value “represents” the capacitance value of the external capacitor on the external node, i.e., the self capacitance of the row or column line.

The current source control value for variable current source 546 is also provided to an adder block 512. The control value establishing the necessary controlled current is stored within a data Special Function Register (SFR) 514 representing the capacitive value of the external capacitance switch. This SFR 514 is a register that allows for a data interface to the CPU 202. Second, an input may be provided to an accumulation register 516 for the purpose of determining that a touch has been sensed on the presently monitored external capacitor switch of the touch screen. Multiple accumulations are used to confirm a touch of the switch, depending upon the particular algorithm utilized. The output of the accumulation register 516 is applied to the positive input of a comparator 518 which compares the provided value with a value from a threshold SFR register 520. When a selected number of repeated detections of activations, i.e., changes, of the associated self capacitance for a given row/column line have been detected, the comparator 518 generates an interrupt to the CPU 202. The output of the accumulation register 516 is also provided to the adder block 512.

Referring now specifically to FIG. 6, there is illustrated a more detailed diagram of the analog front end circuitry 502. The analog front end circuitry 502 includes control logic 530 that provides an output dₒᵤₜ that is provided to the successive approximation register engine 510 and the output clock “clk_out.” dₒᵤₜ indicates a condition indicating that the ramp voltage on C_{EXT} was faster than the ramp voltage across C_{REF}, this indicating that the SAR bit being tested needs to be reset to “zero.” The logic 530 receives an input clock signal “clkn” and provides an output clock signal “clk” and an output clock signal “clkb” (clock bar) to a series of transistors.

The output “clk” is provided to a first n-channel transistor 532. The drain/source path of transistor 532 is connected between node 534 and ground. The gate of transistor 532 is connected to receive the “clk” signal. The gates of transistors 536 and 538 are connected to the clock bar signal “clkb.” The drain/source path of transistor 536 is connected between node 540 and ground, node 540 being connected to an output pad 541 (similar to pin 240) via multiplexer 544. The drain/source path of transistor 538 is connected between node 542 and ground.

The transistors 536, 538 and 532 act as discharge switches for capacitors C_{EXT}, C_{REF} and C_{P2}, respectively. Capacitor C_{EXT} is coupled between the associated output of multiplexer 544 and ground. Capacitor C_{REF} is connected between internal node 542 and ground. Capacitor C_{P2} is connected between internal node 534 and ground. The capacitor C_{EXT} represents the self capacitance of the selected row or column of the touch screen 104 and is variable in value. For example, the capacitive value thereof can change based upon whether the associated capacitor touch pad 106 is being actuated by the finger of the user or not. The multiplexer 544 or other switching circuitry is utilized to connect other external capacitance switches (row or column lines) within the touch screen 104 to node 540 to determine their self capacitance values.

The variable current source 546 provides a current input to node 540. The variable current source 546 (an IDAC) is under the control of a 16-bit data control value that is provided from the successive approximation register engine 510. The current source 546 is used for charging the capacitor C_{EXT} when transistor 536 is off, this providing a “ramp” voltage since current source 546 provides a constant current I_{A}. The current I_{A} is further programmable via current control circuitry 560 that enables the current I_{A} to be modified in order to change the nominal charge time of the capacitor C_{EXT}, i.e., a coarse adjustment. When transistor 536 is conducting, the charging current and the voltage on capacitor C_{EXT} are shorted to ground, thus discharging C_{EXT}.

The current source 548 provides a constant charging current I_{B} into node 542. This charging current provides a charging source for capacitor C_{REF} when transistor 538 is off to generate a “ramp” voltage, and the current I_{B} is sunk to ground when transistor 538 is conducting, thus discharging capacitor C_{REF}. The current I_{B} is variable to provide a fine adjustment and programmable via current control circuitry 562 to provide a coarse adjustment that enables the current I_{B} to be modified in order to change the charge time of the capacitor C_{REF}, i.e., a coarse adjustment during a capacitance value determining step.

Likewise, current source 550 provides a constant charging current I_{C} to node 534. This current source 550 is used for charging capacitor Cₚ₂ to generate a “ramp” voltage when transistor 532 is off, and I_{C} is sunk to ground when transistor 532 is conducting, thus discharging capacitor C_{P2}. The current I_{C} may be variable to provide a fine adjustment and programmable via current control circuitry 564 to provide a coarse adjustment that enables the current I_{C} to be modified in order to change the discharge time of the capacitor C_{P2}.

Connected to node 540 is a low pass filter 552. The low pass filter 552 is used for filtering out high frequency interference created at the self capacitance (C_{EXT}) of the given row/column line in the touch screen 104. The output of the low pass filter 552 is connected to the input of a comparator 554. The comparator 554 compares the ramp voltage at node 540 representing the charging voltage on capacitor C_{EXT} to a threshold reference voltage V_{REF} (not shown) and generates a negative pulse when the ramp voltage at node 540 crosses the reference voltage V_{REF}. This is provided to the control logic 530 as signal “doutb.” Similarly, a comparator 556 compares the ramp voltage of the fixed capacitance C_{REF} at node 542 with the threshold reference voltage V_{REF} and generates an output negative pulse “refb” when the voltage at node 542 crosses the threshold reference voltage V_{REF}. Finally, the comparator 558 compares the ramp voltage at node 534 comprising the charge voltage on capacitor C_{P2} with the threshold reference voltage V_{REF} and generates an output responsive thereto as signal “p2b” when the ramp voltage at node 534 exceeds the threshold reference voltage.

In basic operation, the circuit in FIG. 6 operates by initially resetting the voltage on capacitors C_{EXT} and C_{REF} to zero by turning on transistors 536 and 538. This causes the voltage on capacitors C_{EXT} and C_{REF} to discharge to ground. The transistors 536 and 538 are then turned off, and the voltage on capacitors C_{EXT} and C_{REF} begins to ramp up toward the reference voltage V_{REF} responsive to the current output of the respective current sources 546 and 548. If the voltage across capacitor C_{EXT} reaches the threshold voltage V_{REF} prior to the voltage across capacitor C_{REF} reaching the threshold voltage, this trips the output of comparator 554 to provide a negative pulse and this information is provided from the control logic 530 as output dₒᵤₜ to the successive approximation register engine 510 to allow the SAR bit being tested to remain a “one,” and a next value of the 16-bit control value for the current source 546 will be selected for testing when CREF crosses the threshold reference voltage level V_{REF}. Since the comparator 554 “tripped” before comparator 556, this indicates less current is needed for the next bit tested.

The control logic 530 generates the dₒᵤₜ signal controlling the operation of setting bits of the 16-bit SAR control value by the successive approximation register engine 510 responsive to the output from comparator 554. The successive approximation register engine 510 initially sets a most significant bit of the 16-bit control value to “one” and the rest to “zero” to control the variable current source 546 to operate at one-half value. If the output of comparator 554 goes low prior to the output of comparator 556 going low, the dₒᵤₜ signal provides an indication to the successive approximation register engine 510 to reset this bit to “zero” and set the next most significant bit to “one” for a next test of the 16-bit SAR control value. However, when the output of comparator 556 goes low prior to the output of comparator 554 going low, the bit being tested remains set to “one” and a next most significant bit is then tested. This process continues through each of the 16-bits of the 16-bit control value by the successive approximation register 510 engine responsive to the signal dₒᵤₜ from the control logic 530 until the final value of the 16-bit control value to the variable current source 546 is determined.

The “clkb” output resets the voltages across C_{EXT} and C_{REF} by turning on transistors 536 and 538 to discharge the voltages on these capacitors, and the transistors 536 and 538 are turned off to enable recharging of capacitors C_{EXT} and C_{REF} using the provided respective variable current and the respective reference current, respectively. The voltages across the capacitors C_{EXT} and C_{REF} are again compared by comparators 554 and 556 to the threshold reference voltage V_{REF}. When the output of comparator 556 provides a negative output pulse prior to the output of comparator 554 this provides an indication to set an associated bit in the 16-bit control value to “one” as described above. The 16-bit control value that is being provided to the variable current source 546 will be stored when the SAR algorithm is complete at which point both voltages ramp-up at substantially the same rate. The current I_{A} being provided by the variable current source 546 that is associated with the established 16-bit value, the fixed current I_{B} of current source 548 and the fixed capacitance value C_{REF} may be used to determine the value of the capacitance C_{EXT} according to the equation I_{A}/I_{B}×C_{REF} using associated processing circuitry of the array controller. Even though the actual value of C_{EXT} could be determined with this equation, this is not necessary in order to determine that the self capacitance value of the given row or column line has changed. For capacitive touch sensing, it is only necessary to determine a “delta” between a prior known self capacitance value of the given row or column line and a present value thereof. Thus, by repeatedly scanning all of the external capacitance switches in the capacitive sensor array and comparing a present value therefor with the prior value therefor, a determination can be made as to whether there is a change. Thus, it is only necessary to have a “normalized” value stored and then compare this pre-stored normalized value with a new normalized value. The actual value is not important but only the delta value is important.

By using similar circuitry to generate the ramp voltages and to compare the voltages at nodes 540 and 542, substantially all common mode errors within the circuitry are rejected. Only the filter 552 upsets the common mode balance between the circuits, but this is necessary to prevent high frequency interference from outside sources such as cell phones. The circuitry for measuring the voltages at the nodes provides a proportional balance between the internal reference voltage and the external capacitance voltage. Thus, errors within the comparators or the reference voltage V_{REF} are not critical as they are the same in each circuit. It is noted that, for a given capacitance value determination slip, C_{EXT} and the value of I_{B} are constant, thus setting the maximum time for charging, i.e., the resolution.

The circuitry and functionality described herein with respect to FIGS. 5 and 6 are further detailed in previously incorporated U.S. patent application Ser. No. 12/494,417, filed on Jun. 30, 2009, entitled SYSTEM AND METHOD FOR DETERMINING CAPACITANCE VALUE.

Referring now to FIG. 7, there is illustrated a diagrammatic view of the MTR module 114 interfaced with the touch screen 104. There are illustrated only three rows 108 and three columns 110 for discussion purposes, it being understood that there could be multiple rows and columns in a particular touch screen 104. In this embodiment, the rows are each connected to a separate one of the ADCs 260 which, as described herein above, allows each row line to be sensed individually such that a high speed ADC is not required for individually scanning the analog voltage and the output of a row line with a switched multiplexer. For the generation of the pulse, a single pulse must be generated for each column line 110. Therefore, when a pulse is generated on a particular column line, it will cause charge in the row-to-column capacitor to be transferred to the associated ADC 260 and to convert the value of the transferred charge to a digital value, this digital output value latched in the output for reading by the CPU 202.

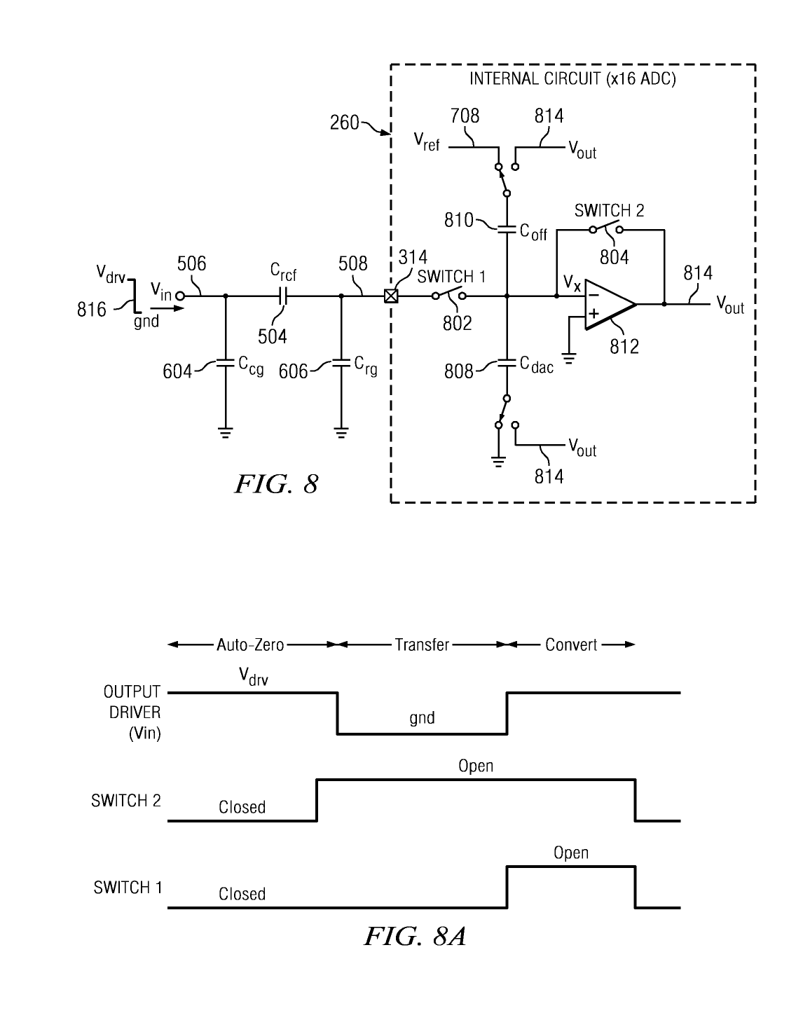

Referring now to FIG. 8, there is illustrated the basic configuration for the ADC 260. For the description of the figure, the rows on the touch screen 104 will be driven with the MTR pulse and the ADCs 260 will be interfaced with the columns. External to the chip at one of the pins 314 associated with a particular MTR in (MTR Rx) input, one column line 508 will be associated therewith. A row line 506 will be driven, it being noted that there will be up to sixteen ADCs 260 associated with sixteen column lines 506 that are perpendicular to the one single row line 506 that is being driven with the negative going edge referred to as V_{IN}. The ADC 260 interior to the IC 102 is defined by a dotted line to indicate that it is interior to the chip. The ADC 260 will be connected to or interfaced to the column line 508 through a pin 314. A switch 802 (switch 1) is operable to switchably connect the column line 508 to an internal node 806. Node 806 is connected to one plate of a capacitor 808 labeled C_{DAC} and also to one plate of a reference capacitor C_{REF} 810. The C_{DAC} capacitor 808 has the other plate thereof connected to ground with the C_{REF} capacitor 810 having the other plate thereof connected to a voltage V_{REF}. Voltage V_{REF} is the voltage sampled onto the capacitor 710 and node 712 and then output on node 708 by buffer 709. The node 806 is connected to the negative input of an amplifier 812, the positive input thereof connected to ground for illustrative purposes. In general, the positive node will be connected to a common mode voltage in most instances, but this could be ground and is illustrated as such for clarity purposes. It should also be noted that this particular amplifier 812 has an offset voltage. Therefore, the negative input will typically be offset by an offset voltage which, for this embodiment, is approximately 900 mV but can vary depending upon the amplifier circuitry. The switch 804 is connected between the node 806 on the negative input of the amplifier 812 and the output thereof to switchably connect the two together and basically short the negative input to the output to provide a unity gain amplifier. The output is labeled V_{OUT}. The purpose for the capacitor C_{OFF} 810 is to guarantee that the amplifier 812 works in the high gain region for the entire range of C_{RCF} such that any voltage variation across C_{DAC} will not go above or below the rail voltage on the output of the amplifier 812.

The plate of capacitor 810 opposite to node 806 that is illustrated as being connected to V_{REF} is actually switchably connectable between V_{REF} on node 708 and the output of the amplifier on a node 814. Thus, the other plate of the capacitor can be connected to two different voltages. Similarly, the other plate of the C_{DAC} capacitor 808, illustrated as being connected to ground, is switchably connectable between ground and the V_{OUT} terminal 814. This will be clearer with the description herein below.

Prior to the describing the operation in detail, the general operation will be described. The goal of the operation is to initially charge up both the row line 506 and the column line 508 in what is referred to as an auto zero mode. This occurs at the high side of V_{IN} at a point 816 at level V_{DRV}. Depending upon the size of the display, the value of C_{RG} (capacitor 604) can be rather large. Similarly, the capacitor C_{CG} could also be large. Thus, there is required a certain amount of time for this capacitor to fully charge to the voltage V_{DRV}. This is a programmable length of time. In order to charge up the node 508, switch 804 (switch 2) is closed such that the unity gain amplifier will drive the negative input. In this configuration, the negative input is essentially disposed at a virtual ground which, if amplifier 812 had no offset, would be the voltage on the positive input thereof. However, with the offset, the negative input will be offset from the positive input by 900 mV in one embodiment. In any event, it will be at a fixed voltage which will cause the node 508 to be charged to the virtual ground voltage, referred to as “V_{X},” and this will charge up the column to ground capacitor 606, the C_{DAC} capacitor and the C_{REF} capacitor to V_{X}. The next step is the sampling or transfer operation wherein the charge from the C_{RCF} capacitor 504 is transferred onto the C_{DAC} and C_{REF} capacitors. To do this, switch 802 is maintained in a closed position but switch 804 is opened and the C_{REF} and C_{DAC} capacitors are connected in parallel between node 806 and the output of amplifier 812. This will effectively maintain the negative input at the virtual ground level V_{X} that existed when switch 804 was closed. This will keep the column line 508 and the node 806 at the same voltage and then V_{IN} is moved from the V_{DRV} voltage to ground. This will effectively transfer the charge on capacitor 504 to the C_{REF} and C_{DAC} caps. A conversion operation is then implemented wherein the column line 508 is isolated from node 806 and then the charge difference on the C_{DAC} and C_{REF} capacitors determined with a successive approximation register (SAR) algorithm to determine a digital voltage representing the difference in charge. By isolating the column line from the ADC 342, any noise that might occur during the conversion process will also be isolated. Thus, the operation will entail first charging up the capacitor 504, the C_{RCF} capacitor, with a quantum of charge. This quantum of charge is then transferred onto an internal capacitor or capacitors to change the charge disposed therein. This is followed by a determination of the change in charge. It is this change in charge that correlates to the charge on the capacitor 504. As will be described herein below, since the voltage on node 806 is maintained at the same voltage for the initial auto zero or charging operation of the column line and the charge transfer operation, this column-to-ground capacitor is effectively canceled out from the operation.

Referring now to FIG. 8A, there is illustrated a timing diagram for the MTR operation. This MTR operation consists of three phases, an auto zero phase, a transfer phase and an A charge to digital conversion phase. The first waveform illustrates the input driver signal that drives the row. This is a signal that is shifted between the drive signal V_{DRV} and ground. Initially, in the auto zero phase, switch 804 (switch 2) is closed and switch 802 (switch 1) is closed. This allows both the column line 508 and the row line 506 to be charged up. As noted herein above, the column line is charged to virtual ground V_{X} on the negative input of the amplifier 812. With the offset, this differs from the common mode voltage (or ground) on the positive input of the amplifier 812 by that offset voltage.

In the next phase, the transfer phase, switch 804 (switch 2) is opened and the voltage of V_{IN} driven to ground to transfer charge from the C_{RCF} capacitor (504) to the C_{DAC} and C_{OFF} capacitors. Switch 802 (switch 1) still remains closed. Note that, when switch 804 is open, the opposite plates of C_{DAC} and C_{OFF} which were originally connected to ground and V_{REF}, respectively, will be switched to V_{OUT}. This effectively transfers a charge onto C_{DAC} and C_{OFF}. At the end of the transfer phase, the convert phase is initiated with switch 804 still remaining open. The opposite plates of capacitor C_{DAC} and C_{OFF} from node 806 are again switched to ground and V_{REF}, respectively, and then switch 802 (switch 1) opened. During this phase, the amplifier 812 functions as a comparator in a SAR conversion operation, which will be described herein below.

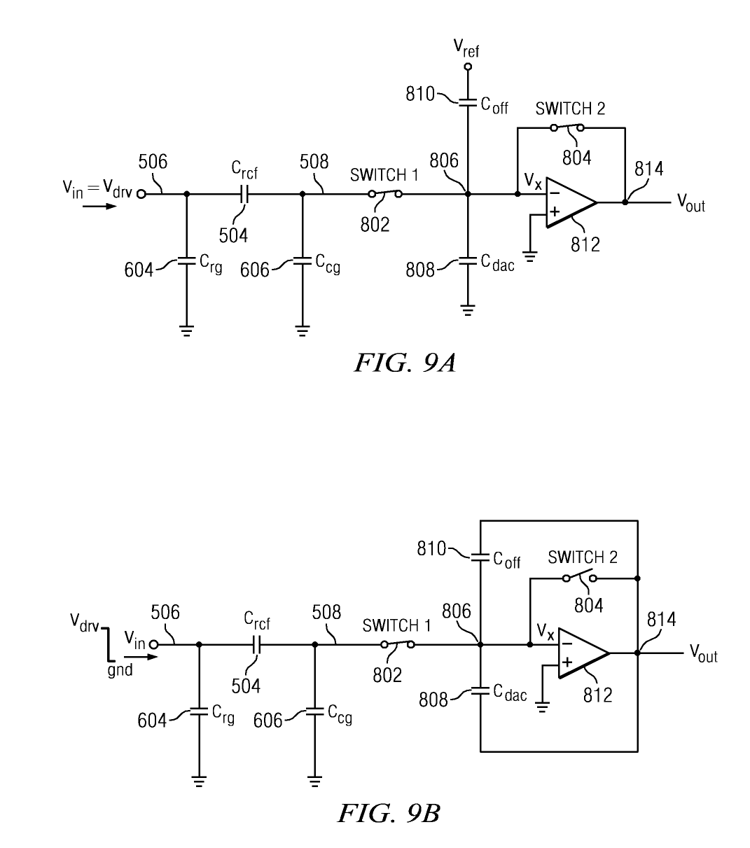

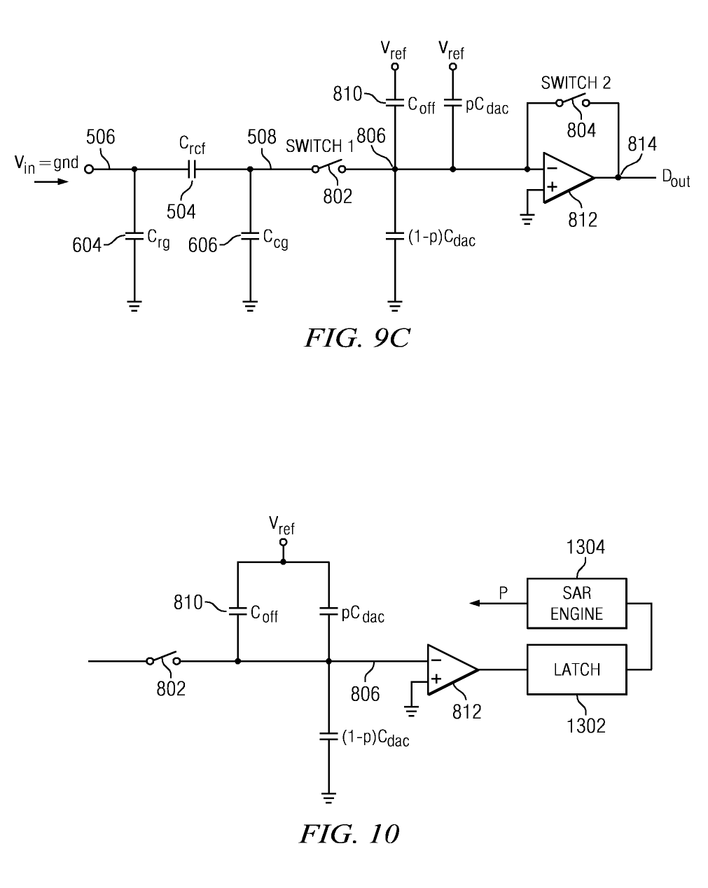

With specific reference to FIG. 9A, there is illustrated a configuration for the auto zero phase. In this configuration, switch 804 (switch 2) is closed thus driving the negative input of amplifier 812 on node 806 to virtual ground which will charge node 806 to the virtual ground voltage V_{X}. This will result in a voltage across C_{DAC} of V_{X}, a voltage across C_{OFF} of V_{REF}−V_{X}, a voltage across C_{CG} of V_{X} and a voltage across C_{RCF} of V_{DRV}−V_{X}. The charge on the plate 806 is referred to as the total charge or Qₜₒₜₐₗ. Since the charge across the capacitor is set by the relationship Q=CV, the following relationship will exist for Qₜₒₜₐₗ:

Qtotal=−Vin·Cref−Vref·Coff+Vx·Ctotal

Where: Ctotal=Crcf+Coff+Cdac+Ccg

Thus, the amplifier 812 was configured as a unity gain op-amp to basically set up a virtual ground at the inverting input thereof on node 806. The next step is to go to the transfer phase illustrated in FIG. 9B. In this phase, the opposite plates of C_{OFF} and C_{DAC} from node 806 are connected to the V_{OUT} terminal 814. Then, V_{IN} is dropped from the V_{DRV} drive level to ground. This will force charge onto the C_{OFF} and C_{DAC} capacitors because the node 806 is at a virtual ground level at voltage V_{X} and is maintained there by the amplifier 812 configured as a unity gain op-amp. This will cause the charge on capacitors C_{DAC} and C_{OFF} to change. It can be seen that the charge on the capacitor C_{OFF} and C_{DAC} would be defined by the relationship Q=(V_{O}−V_{X})(C_{DAC}+C_{OFF}) before charge is transferred thereto. This charge would be changed once V_{IN} was lowered. When V_{IN} is lowered, it is noted that only the charge on the C_{RCF} capacitor 504 is transferred because the voltage across the C_{CG} capacitor 606 has not changed. The result of V_{IN} going from V_{DRV} to ground causes an increase to the charge in C_{RCF}, thus decreasing the charge in C_{OFF} and C_{DAC}. The following relationship exists with respect to the total charge on the node 806:

Qtotal=−Vout·(Cdac+Coff)+Vx·Ctotal

Where: Ctotal=Crcf+Coff+Cdac+Ccg

After the defined time during which the charge will transfer, the conversion operation is then entered, this being a SAR conversion operation, as illustrated in FIG. 9C. Prior to the conversion operation, however, switch 802 is opened to isolate the column line 508 from the ADC 342 such that any external noise such as white noise, etc., will not affect the conversion operation. Since the charge has already been transferred to C_{OFF} and C_{DAC}, all that is necessary is to determine the amount of charge transferred thereto.

During the conversion operation, the switches that switch the opposite plates of C_{DAC} and C_{OFF} to V_{OUT} are reconnected to ground and V_{REF}, respectively, such that the capacitors are in substantially the same condition as the auto zero phase. Initially, C_{DAC} at full value is connected between node 806 and ground. Since charge has been reduced and the amplifier 812 is now in an open loop configuration such that it is no longer operating as an op-amp and, thus, does not hold the inverting input thereof at the virtual ground level, what will occur is that the voltage on node 806 will change, i.e., it will not be at V_{X}. Thus, the output of the amplifier 812, it now functioning as a comparator, will be high or low. What then occurs is that the value of C_{DAC} is ratioed such that a portion thereof will be connected from node 806 to V_{REF}. The capacitor C_{DAC} is set at a value of approximately 5 pF which is essentially the approximate value of the row-to-column capacitance C_{RCF}. It is configured utilizing a plurality of unit caps of value “C” connected in parallel to provide a 5 bit binary set of capacitors, i.e., capacitors C, 2C, 4C, 18C and 16C, and a 5-bit thermometer code utilizing 31 unit caps of value. These can be configured such that the portion of C_{DAC} that is connected between node 806 and ground will have a value of (1−p)C_{DAC} and the portion of C_{DAC} connected between node 806 and V_{REF} will be pC_{DAC}. It can be seen that if p=0, this would indicate that the value of C_{RCF} would be equal to zero. This would be expected in that no change in the charge across C_{DAC} and C_{OFF} existed and, therefore, the voltage on node 806 would essentially be V_{X}, a voltage right at the trigger point for amplifier 812 configured as a comparator. When C_{RCF} is not zero, and charge has been transferred, the SAR algorithm will be required to vary the value of p until the voltage on node 806 is approximately equal to V_{X}, the trip voltage. At this point, there will be a digital value associated with the value of p which will equal the digital value corresponding to the charge on C_{RCF}. Thus, what has been achieved is an analog-to-digital converter that converts charge to a digital value. It is a charge-to-data converter in essence. The relationship for Qₜₒₜₐₗ for node 806 during the conversion operation is, for the configuration illustrated, as follows:

Qtotal=−Vref·(Coff+pCdac)+Vx·Ctotal

Where: Ctotal=Crcf+Coff+Cdac+Ccg

Referring now to FIG. 10, there is illustrated a diagrammatic view of the SAR engine during the conversion phase. During this phase, the amplifier 812 is configured as a comparator and switch 802 (switch 1) is open, thus isolating node 806 from the array and, thus, preventing any noise from being passed across switch 802 from the array. C_{DAC}, as described herein above, is comprised of multiple capacitors such that a portion of the capacitor C_{DAC} can be disposed between node 806 and ground and a portion can be disposed between node 806 and V_{REF}. The output of amplifier 812 is input to a latch 1302, the output thereof utilized by a SAR engine 1304 to generate the value of “p.” The C_{DAC} capacitor is comprised of a 5-bit binary capacitor section and a 5-bit thermometer section. The binary section is comprised of a combination of unit capacitors which stores a value “C” such that the capacitors in the 5-bit binary array are C, 2C, 4C, 8C and 16C, resulting in 32 unit capacitors. The thermometer portion will have 2⁵−1 capacitors or 31 capacitors of size 32C. This type of DAC is usually referred to as a hybrid DAC wherein the thermometer coded bits are associated with the five most significant bits and the binary weighted bits are associated with the five least significant bits. With the binary weighted portion of the DAC, elements corresponding to the more significant bits are weighted higher than elements corresponding to the less significant bits. With respect to the thermometer coded DAC portion, the number of asserted bits in the thermometer code would be proportional to the value of the digital signal and each bit of the thermometer code is provided to a corresponding capacitor. All that is required is a binary to thermometer decoder to generate the thermometer code from the binary code.

During the SAR operation, the first step will be to assert the most significant bit and determine if node 806 is at or below the trip point. As described herein above, the trip point will be the virtual ground which is basically the voltage offset from the positive input voltage. Even though this voltage is illustrated as being connected to circuit ground, it would typically be connected to a common mode voltage generated on-chip. Thus, when the voltage goes above the trip point, the output of amplifier 812 will go negative and, when it is below the trip point, the output will go positive. The SAR engine 1304 will test each bit to determine if the voltage on node 806 is above or below the trip point. If it is below the trip point, that bit will be maintained as a latched value and then the next value tested, such that each lower MSB can be tested in sequence. If the next MSB causes the voltage to go above the trip point, this bit is maintained at a logic “0” for the value “p.” At the end of the SAR operation, after 10 bits, the value will be latched and this will constitute the result. What this value indicates is a digital value corresponding to the charge that was transferred to C_{OFF} and C_{DAC}. As noted herein above, if the value of the transferred charge were “0,” there would have been no change in the charge stored on C_{OFF} and C_{DAC} and the voltage on node 806 in that situation would have been equal to the trip point voltage (the virtual ground voltage) and the result would be that value of “p” would be equal to zero. Thus, by transferring the charge to the capacitors C_{OFF} and C_{DAC} and then isolating node 806 from the array, a conversion can be made to a digital value that represents the charge on C_{RCF}. This is thus a data converter that converts charge to a digital value or a charge-to-digital converter.

The value output by the ADC 260 is utilized to determine whether there has been a change in the capacitance value or the charge stored on the capacitor. In the presence of a touch, the column to ground capacitance will increase and the column-to-row capacitance (C_{RCF}) will decrease. If the decrease is beyond a certain threshold, a decision can be made that this is a “touch” condition. However, scanning of an array will usually result in a no-touch decision since the display is idle a large percentage of the time with respect to the user interface thereto. Thus, it is the desire to minimize the amount of power required to make the determination that there is a “no-touch” condition.

To determine that there is a touch requires one to compare a current value of C_{RCF} to a prestored value representing the no-touch situation. This is referred to as the “baseline value.” The baseline value for each of the C_{RCF} capacitors in the array will be determined during a calibration operation. This calibration operation can be user initiated or it can be automatically based on time or even temperature. When the temperature of the device containing the touch screen and the chip changes, this can change the values of the capacitor C_{RCF} and, therefore, there must be some type of calibration.

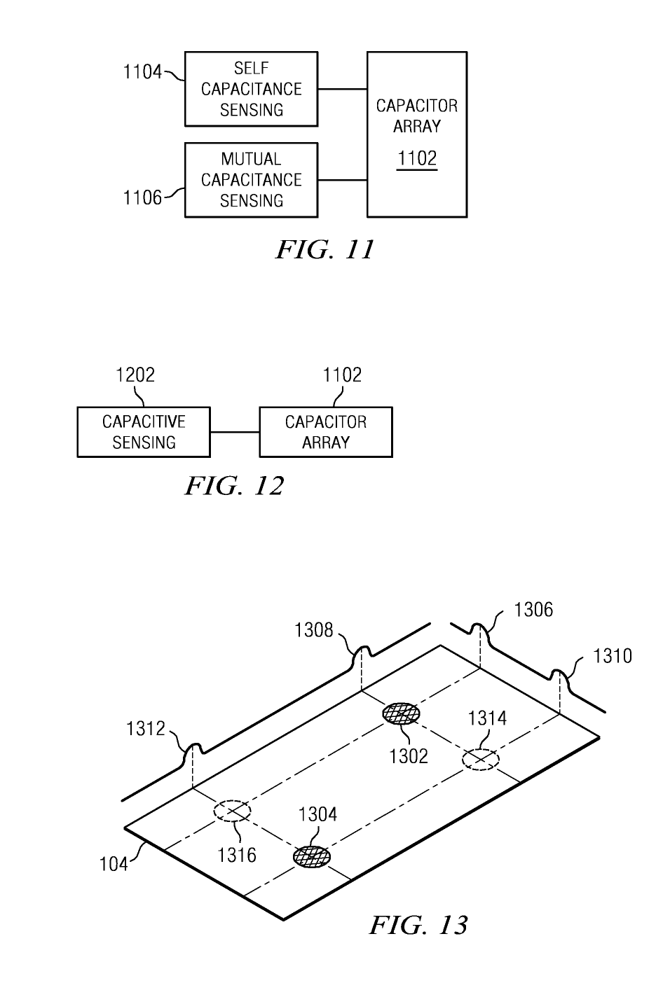

FIG. 11 illustrates a general block diagram for one method for detecting touches upon a capacitor array 1102. In this case, a self capacitance sensing circuit 1104 and a mutual capacitance sensing circuit 1106 are each used for detecting capacitive touches within the capacitive sensor array 1102. Self capacitive sensing circuitry 1104 are used within the low power mode of operation of the circuitry. The self capacitive sensing array 1104 can only perform row and column scanning with respect to the capacitive sensor array 1102. The row and column scanning process performed by the self capacitive sensing circuitry 1104 separately scans the rows and columns associated with the capacitive sensor array. The self capacitive sensing circuit 1104 operates in the same way as the capacitive sense block 112 described herein above with respect to FIG. 1 in one embodiment. The self capacitance sensing circuitry 1104 can only provide general row and column information with respect to an area in which a touch is detected within the capacitive sensor array 1102. The self capacitive sensing circuit 1104 can not provide specific location information within the capacitive sensor array. This type of sensing requires a higher power mutual capacitive sensing circuit 1106 that initializes a different scanning technique for the scanning operation.

The mutual capacitive sensing circuitry 1106 may, in one embodiment, comprises the MTR circuitry 114 described herein above with respect to FIG. 1. The mutual capacitive sensing circuitry 1106, rather than performing separate row and column scanning within the capacitor array 1102, may scan each intersection within the X/Y array forming the capacitive array 1102. Thus, rather than determining generally on what row and/or column a touch has been detected, the mutual capacitive sensing circuitry 1106 can monitor for a capacitive touch at or proximate to each intersection of the rows and columns within the capacitor array 1102. This provides a much higher resolution scan. Thus, by using two different types of scanning, there is provided the flexibility of optimizing the scanning operation by alternating between the two different blocks.

In a further embodiment illustrated in FIG. 12, rather than using different high power and low power capacitive sensing circuitry within the capacitor array 1102, a single capacitive sensing circuitry 1202 may be used for sensing the touches within the capacitor array 1102. In this case, the capacitive sensing circuitry 1202 would have high power and low power modes of operation wherein the low power mode of operation enables a coarse scanning operation to be performed where the general area of a touch within the capacitive array 1102 could be detected. This mode would be performing the same sensing operations done by the self capacitive sensing circuitry 1104 described with respect to FIG. 11. In the higher power mode of operation, the capacitive sensing circuitry 1202 would perform a fine resolution scan wherein a more accurate determination of the position of a touch within the capacitor array 1102 could be made. The higher power capacitive sensing mode of operation by the capacitive sensing circuitry 1202 would be performed only in the areas in which the low power mode of operation had detected a touch within the capacitor array 1102. This will allow high power scanning within a smaller area of the capacitor array 1102 enabling the overall use of less power. The higher power mode of operation corresponds to the operations performed by the mutual capacitive sensing circuitry 1106 discussed with respect to FIG. 11. Further, the capacitive sensing circuitry 1202 could be utilized to provide high and low power scans to “zero” in on the desired area and then switch to the mutual capacitance sensing. As an example, consider that a low power, low resolution scan is running with the capacitance scanning circuitry 1202 just to determine if there is a change in capacitance anywhere on the capacitance array. Then, the higher power, slower scan (higher resolution) mode is entered, to confirm not only that a “touch” occurred, but the location thereof. Then, the system could be switched to the mutual capacitance circuitry 1106 to resolve any ambiguities in the event that a multiple touch has occurred or that the system is operating in a multiple touch application.

Referring now to FIG. 13, there is illustrated a diagrammatic view of the touch screen 104 illustrating multiple touches when scanning in the self capacitance mode. In the self capacitance mode, a touch will be represented by a plurality of regions defined by intersections between rows and columns, where the value of the self capacitance for a row line or a column line changes as a function of the strength of the touch. At the center of the touch, the strength will be stronger than at the edges of the touch and, as such, there will be a bell curve (for exemplary purposes) associated therewith.

In the embodiment illustrated in FIG. 13, there are illustrated two actual touch areas 1302 and 1304. The touch area 1302 will yield a curve 1306 on the column and a curve 1308 on the row. A second touch area 1304 disposed apart from the touch area 1302 will yield a curve 1310 on the column output and a curve 1312 on the row output. It can be seen that, since there are two column outputs 1306 and 1310 and two row outputs 1308 and 1312, there is an ambiguity that exists, i.e., it is difficult to determine whether the curve 1306 or the curves 1310 goes to the first touch or to the second touch. This is also the case with respect to the curves 1308, and 1312. Thus, there will a ghost touch 1314 associated with curves 1310, 1308, and a ghost touch 1316 associated with the curves 1312, 1306. This, of course, can be resolved with the MTR scanning utilizing mutual capacitance scanning. However, in some situations, it is desirable to utilize only self capacitance scanning due to speed and power considerations.

Once a touch region has been determined either by the self capacitance scanning method or by the mutual capacitance scanning method, it may be necessary to track the touch across the touch screen 104 in some applications. For example, some applications require two fingers in order to cause an image to “zoom out.” This is effected by placing the fingers close together on the touch screen and then moving them outward from each other. For such algorithms, the ambiguity illustrated in FIG. 13 may not that important. However, for some other type of applications, it is more important to more accurately track both fingers in a dual finger situation.

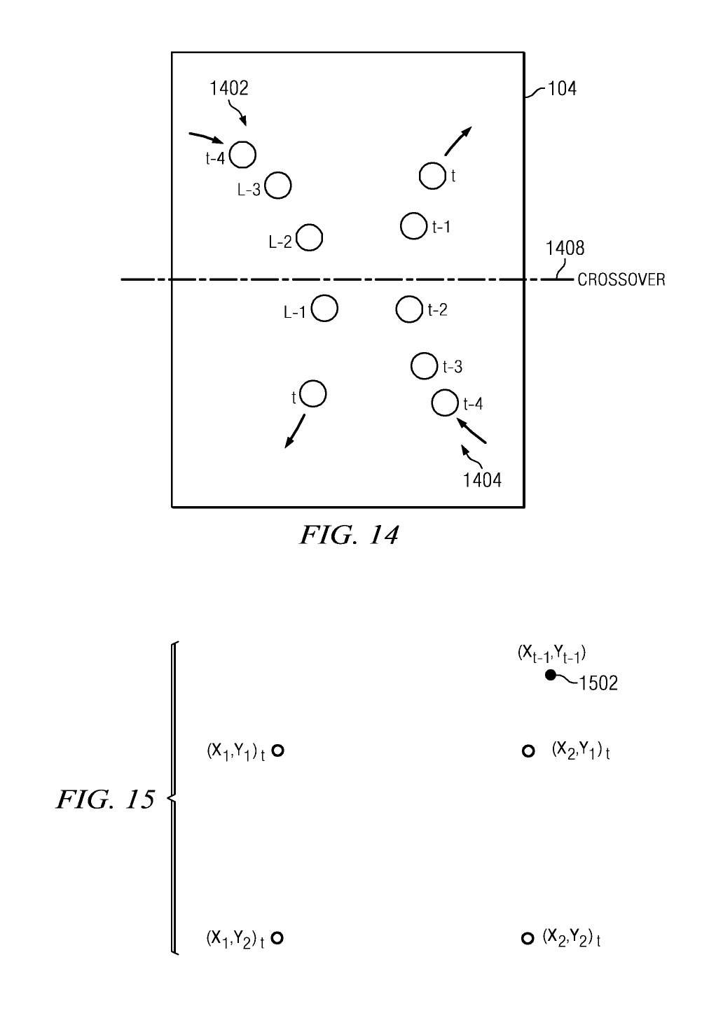

Referring now to FIG. 14, there is illustrated one example of the movement of two fingers across the touch screen. This is illustrated as a first touch path 1402 on the left side of the display 104 associated with one finger and a second touch path 1404 on the right side of the touch screen 104 associated with another finger. The two paths are illustrated as traversing from one corner to the other corner, with the path 1402 for the one finger traversing from the upper left hand corner across the middle of the screen 104 to the lower left hand corner, and with the path 1404 traversing from the lower right hand corner across the middle of the touch screen 104 to the upper right hand corner. Both paths 1402 and 1404 are shown moving in an arcuate path.

It is noted that the touch screen 104 requires a finite amount of time to scan the display, store the determined capacitive value and wake up the processor for the purpose of processing the stored information to make a determination as to whether there has been a touch and where that touch is located. A typical scan can be effected in approximately 10 ms. Thus, the values for a given path traversal will be illustrated as discrete points. These are labeled with respect to time. The current time is “t” with the prior time being “t−1.” There are illustrated five incremental determined locations in each traversal path from “t” to “t−4.” There is illustrated a central crossover line 1408 that represents a point where both paths 1402 and 1404 cross a common axis such that the output for a given row will be common, i.e., it is determined that both touches exist on the same row. This is referred to as the touch crossing. Further, the speed of the paths can be determined by the distance between each scan output for a given path.

The basic algorithm to track multiple fingers on a touch screen and determine where each of the fingers is moving, i.e., determining the traversal path, utilizes two approaches, a comparison to a last known location approach and a predictive approach. In the first approach, as long as the fingers have not crossed, the algorithm will utilize the last known location for a first finger and then calculate the distance between the potential four locations of the current measurement and the last known location. For this calculation, one of the touches will be a primary touch and the other will be a secondary touch. The first finger is the primary touch and this is utilized as the reference.

In the last known location approach, the point or region that is determined to be the shortest distance away from the last known location is considered to be the next location for the first finger. The remaining or complimentary XY coordinate pair (different X and Y coordinates) will be designated as the location for the second finger or the secondary location. However, if the fingers are determined to be on the same axis, i.e., they are at the crossover point, using the shortest distance from the previous location could cause the algorithm to incorrectly predict that the first finger was returning along the same path it just traversed, rather than continuing to pass the second finger in one direction. At this point, a predictive algorithm is utilized which will predict the direction of movement of the finger and then determine where the finger will be next. This predicted location ahead of the finger's current location will ensure that the finger is closer to the point passed where it currently is. The predicted location is calculated using the previous known location and the oldest known location of the first finger.

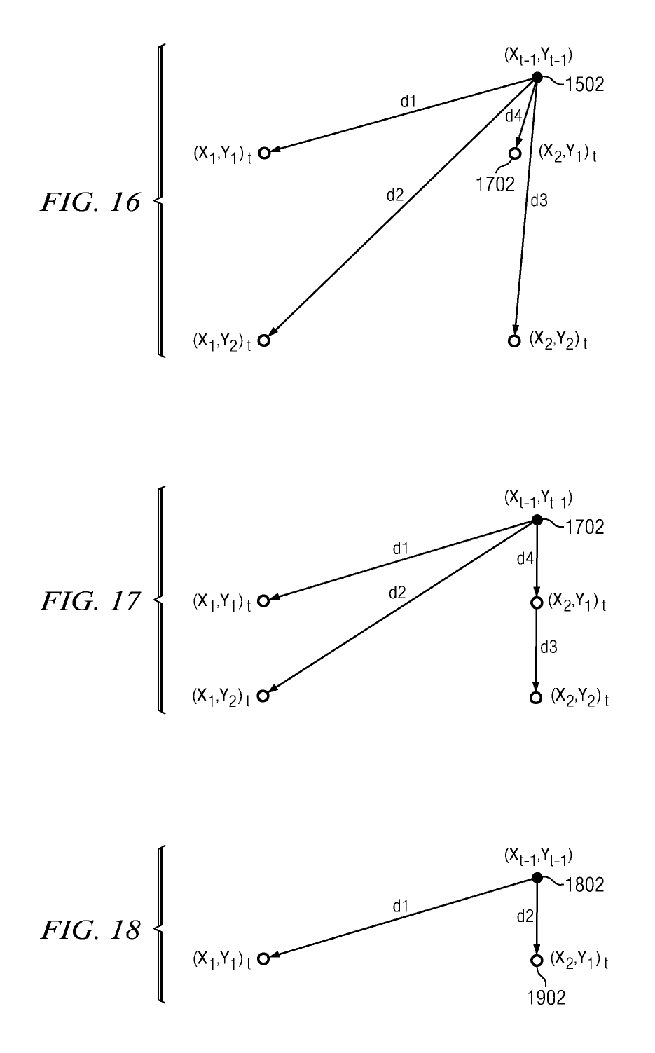

Referring now to FIG. 15, there is illustrated a graphical view of the last known location operation wherein a last known location 1502 is labeled (Xₜ₋₁, Yₜ₋₁). The next location is defined by four sets of potential XY coordinates for time “t.” They are the coordinates (X₁, Y₁)ₜ, (X₁, Y₂)ₜ, (X₂, Y₁)ₜ, and (X₂, Y₂)ₜ. The goal of the last known location algorithm is to determine the minimum distance to one of these four coordinates. This is illustrated in FIG. 16.

In FIG. 16, it can be seen that the last known location 1502 will have a distance d1 to coordinates (X₁, Y₁)ₜ, a distance d2 to coordinates (X₁, Y₂)ₜ, a distance d3 to coordinates (X₂, Y₂)ₜ, and a distance d4 to coordinates (X₂, Y₁)ₜ. In the illustration in FIG. 16, the shortest distance is d4 to coordinates (X₂, Y₁)ₜ. This will therefore be the determined as next location for the first finger, the primary touch. This assumes that the scan time is fast enough that a finger will not move far enough to violate the distance check algorithm. Thus, the secondary touch or second finger will be determined to be present at the coordinates (X₁, Y₂)ₜ.

Referring now to FIG. 17, there is illustrated an additional step wherein the fingers move closer together. The last known location will be a location 1702, which corresponds to the coordinate pair (X₂, Y₁)ₜ associated with the distance d4 in FIG. 16. Thus, at the location 1702, this will now be the last known location at coordinates (Xₜ₋₁, Yₜ₋₁). The next set of coordinates determined for the scan at time “t” will be the same four coordinate sets (X₁, Y₁)ₜ, (X₁, Y₂)ₜ, (X₂, Y₁)ₜ, and (X₂, Y₂)ₜ. The distance from the last location 1702 to the coordinate location (X₁, Y₁)ₜ is d1, the distance to coordinate location (X₁, Y₂)ₜ is d2, the distance to coordinate location is (X₂, Y₂)ₜ is d3, and the distance to coordinate location is (X₂, Y₁)ₜ is d4. In this illustration, the illustration shows that coordinate location (X₂, Y₁)ₜ, and (X₂, Y₂)ₜ have the same X coordinate value as Xₜ₋₁. The shortest distance illustrated is d4 to coordinate location (X₂, Y₁)ₜ. As long as the fingers have not crossed over, i.e., Y₁=Y₂ or X₁=X₂ (or there is a “substantial” equality), this decision process will continue to provide a valid result.

Referring now to FIG. 18, there is illustrated a diagrammatic view illustrating the operation wherein the last location, defined by a location 1802, moves to a location for the first finger that is on the same axis (X or Y) and the vector algorithm still provides the correct decision. In this embodiment, it can be seen that the scanning operation will only determine two touch regions, at coordinate locations (X₁ Y₁)ₜ, (X₂, Y₁)ₜ. The movement for a primary finger from the last location (Xₜ₋₁, Yₜ₋₁) will either move to coordinate location (X₂, Y₁)ₜ or to (X₁ Y₁)ₜ. The distance to (X₁ Y₁)ₜ is d1 and the distance to (X₂, Y₁)ₜ is d2, with d2 being determined as the shortest distance and, therefore, the coordinate location (X₂, Y₁)ₜ being the location for the first finger and coordinate location (X₁ Y₁)ₜ being determined as the location for the second finger on the secondary touch.

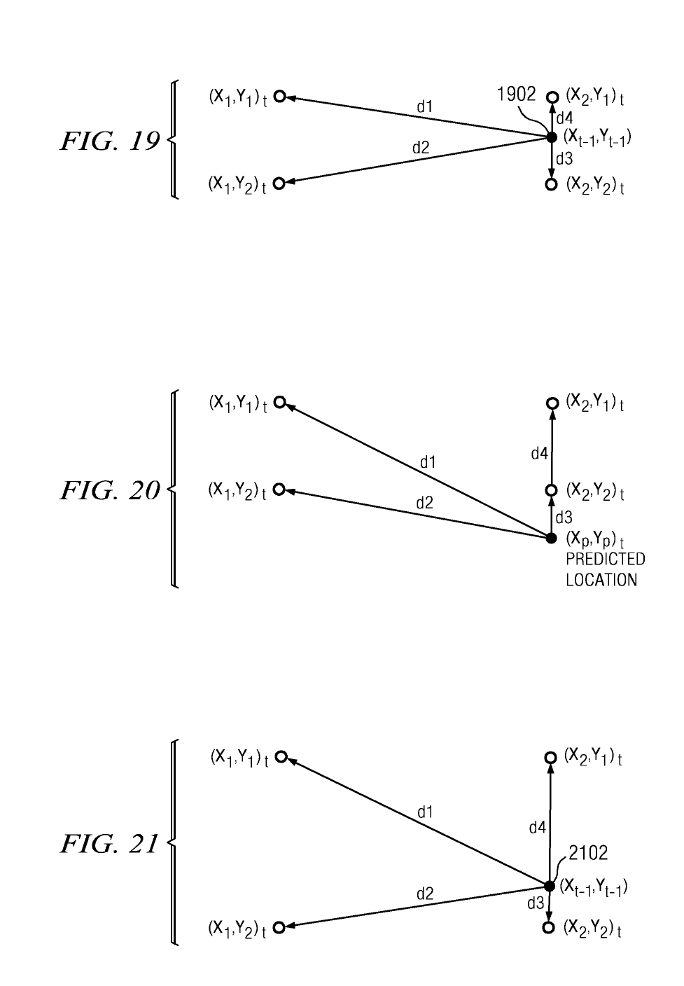

At this point in the finger movement, this situation where the two fingers are on the common axis, a crossover will be detected, i.e., the two paths are crossing over. This next movement will be illustrated in FIG. 19. The last known location is at a location 1902, which corresponds to the coordinate location (X₂, Y₁)ₜ in FIG. 18. The next movement will result in the fingers moving apart such that they are no longer on the common axis and there will now be four potential locations to which the first finger could move, they being four coordinate locations (X₁, Y₁)ₜ, (X₁, Y₂)ₜ, (X₂, Y₁)ₜ, and (X₂, Y₂)ₜ in FIG. 19. The distance to the coordinates (X₁, Y₁)ₜ is d1, the distance to the coordinates (X₁, Y₂)ₜ is d2, the distance to coordinates (X₂, Y₂)ₜ is d3, and the distance to the coordinates (X₂, Y₁)ₜ is d4. In the illustrated diagram of FIG. 19, distance d4 is the smallest distance. Therefore, if the last known location approved were utilized, the next location would be (X₂, Y₁)ₜ. This would be incorrect, as the last two moves for the finger were in a downward direction toward coordinate location (X₂, Y₂)ₜ. However, the last known location algorithm would incorrectly select (X₂, Y₁)ₜ since d4 is shorter.

Referring now to FIG. 20, there is illustrated a diagrammatic view of how the predictive portion of the algorithm is utilized. This mode is selected, after the determination is made that the fingers are crossing, i.e., the previous calculation was made with coordinate locations that had one substantially common axis. Due to the distance that the fingers travel for a given scan, this could result in a common axis being on the exact same row or within less than a predetermined delta for that distance from the common axis. In this mode, the last known location and the oldest known location that were stored in the memory as history for the primary touch would be analyzed to determine a predicted location (Xₚ, Yₚ)ₜ. This type of prediction could be implemented in multiple ways. In one method, the distance previously determined for the last known location could be utilized in conjunction with the oldest known location to determine a direction for the predicted location and a distance. The distance could be the distance between the last known location and the oldest known location. If the oldest known location involved more than one sample of history, this would result in a large move and, if it were one sample of history, this would result in a smaller move. In the illustration in FIG. 20, it is noted that the predicted location (Xₚ, Yₚ)ₜ is actually an overshoot of the actual measured location at coordinates (X₁, Y₁)ₜ, (X₁, Y₂)ₜ, (X₂, Y₁)ₜ, and (X₂, Y₂)ₜ. This will result in a distance of d1 from the predicted location to (X₁, Y₁)ₜ, a distance of d2 to (X₁, Y₂)ₜ, a distance of d3 to (X₂, Y₂)ₜ, and a distance of d4 to (X₂, Y₁)ₜ. It will be seen that the distance d3 is the shortest distance and, therefore, coordinate location (X₂, Y₂)ₜ is the location of the primary touch and coordinate location (X₁, Y₁)ₜ is the coordinate location for the secondary touch or the location of the second finger.

Referring now to FIG. 21, it can been seen that, once the fingers cross, the algorithm can then return to using finger one's previous location to calculate the last known location in accordance with the last known location algorithm. This shows the next step wherein the last known location, represented by a location 2102 for last known coordinate location (Xₜ₋₁, Yₜ₋₁) is utilized to determine the distance to coordinate location (X₁, Y₁)ₜ as d1, the distance to coordinate location to (X₁, Y₂)ₜ as d2, the distance to coordinate location (X₂, Y₁)ₜ as d4 and the distance to coordinate location (X₂, Y₂)ₜ as d3. The distance d3 is the shortest distance and, therefore, coordinate location (X₂, Y₂)ₜ is the current location of the first finger, the primary touch, and the complimentary coordinate location (X₁, Y₁)ₜ is the coordinate location for the second finger or secondary touch. It is noted that, since the second finger is moving upward to the left, the distance d4 would have a larger value than the distance d3.

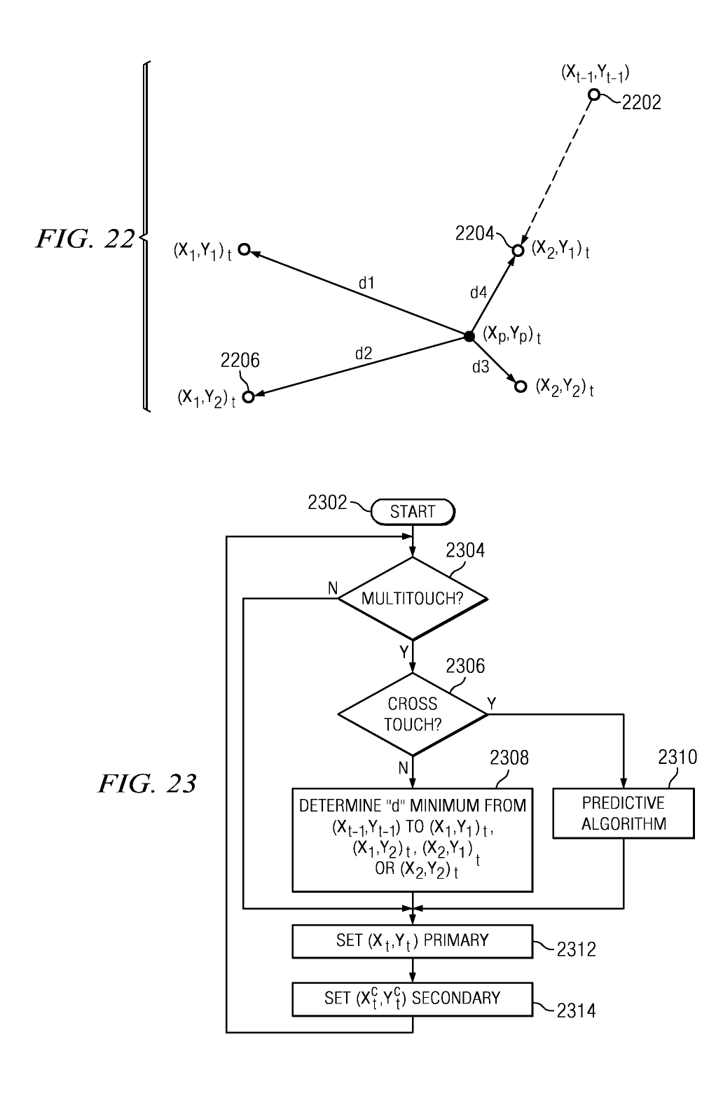

As noted hereinabove, the last known location algorithm, utilizing the past location only could always be utilized. However, this could cause issues after the fingers crossed. Additionally, the predictive algorithm could always be utilized, but this could cause a problem before the fingers crossed. This is illustrated in FIG. 22. It can be seen that there is a past or last known location 2202 that occurred prior to a finger crossing whereas the next location should be a location 2204 for the primary touch and the coordinate location 2206 would be the coordinate location for the second finger or secondary touch. However, in the predictive algorithm, a predictive value (Xₚ, Yₚ)ₜ for the predicted coordinate location would have a distance determined therefrom to the other four potential coordinate locations (X₁, Y₁)ₜ, (X₁, Y₂)ₜ, (X₂, Y₁)ₜ, and (X₂, Y₂)ₜ. The distance from the predicted location to coordinate location (X₁, Y₁)ₜ is d1, to coordinate location (X₁, Y₂)ₜ is d2, to coordinate location (X₂, Y₂)ₜ is d3, and to coordinate location (X₂, Y₁)ₜ is d4. In the illustrated embodiment, the distance d3 is the shortest distance since the prediction overshot the coordinate location 2204. This would result in a mistakenly designated primary touch at coordinate location (X₂, Y₂)ₜ. Thus, the distance measurement using the last known location only would be the proper algorithm to utilize at this time. Thus, utilizing a hybrid algorithm that switches from the last known location algorithm to the predictive algorithm at the crossover point and then back provides the best results.

Referring now to FIG. 23, there is illustrated a flow chart depicting the algorithm, which is initiated at a block 2302. The program then flows to a function block 2304 to determine if there are multiple touches detected. If yes, the program flows to a function block 2306 to determine if it a cross touch, i.e., are the two fingers crossing such that they share a substantially common axis. If not, this indicates that the last known location algorithm should be utilized and the program flows to a function block 2308 and, if not, this indicates that the predictive algorithm should be used, as indicated by a function block 2310. For the function block 2308, all that is determined is the minimum distance “d” from (Xₜ₋₁, Yₜ₋₁) to the closest one of the four coordinates. This utilizes only the last known location. Once this is determined, the program flows to a function block 2312 to set the current coordinate value for the primary touch (Xₜ, Yₜ) and the value for the secondary touch as the compliment coordinate (Xₜ^{c}, Yₜ^{c}), as indicated by a function block 2314. The program then flows back to the input of decision block 2304.

In order to initiate the overall operation of the system, there must be some type of history for a primary touch and a secondary touch. In one mode, it is possible to set the primary touch as the first touch detected. This is the first time the touch screen is activated where there is no ambiguity. Typically, when two fingers touch the touch screen, one will touch first and then the second one will touch. Thus, the self capacitance scanning can be utilized to set the first touch as being the primary touch, i.e., the first finger. Alternatively, the MTR block may be utilized to initially define with certainty the location of one of the fingers and designate this as the “first” finger or primary touch. Thus, after one of the fingers is set as the first finger as being a known location, it is then possible to track the two fingers using the algorithms described hereinabove.

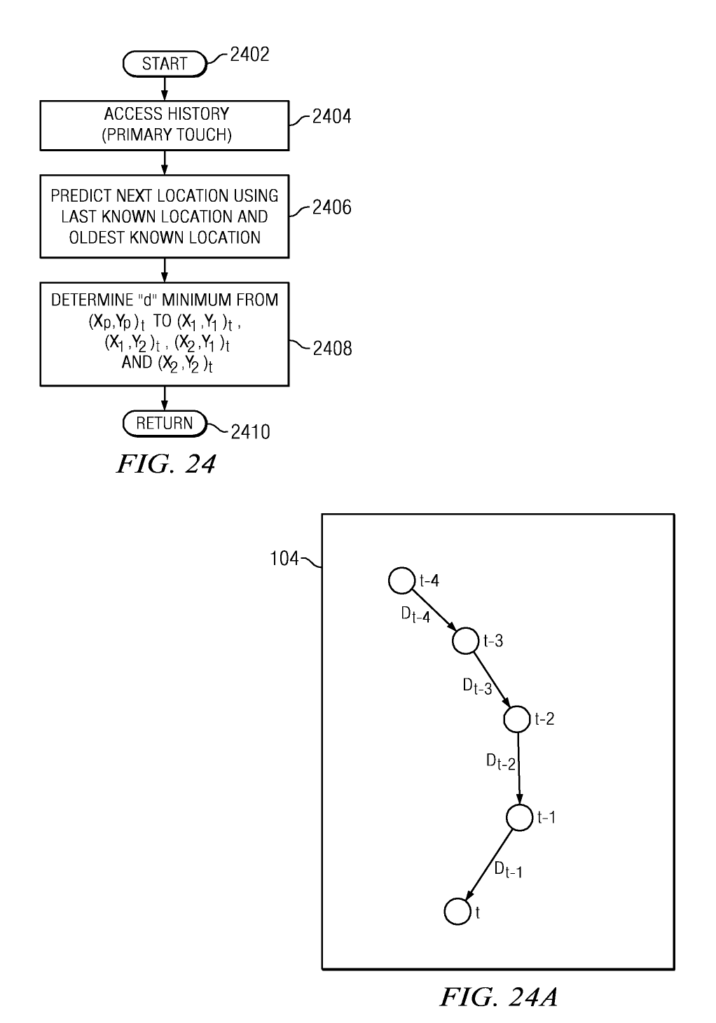

Referring now to FIG. 24, there is illustrated a flow chart for the predictive algorithm. The program is initiated a block 2402 and then proceeds to a function block 2404 to access the history for the primary touch. The program then flows to a function block 2406 to predict the next location utilizing the last known location and the oldest known location. This is the simplest form of prediction. The program then flows to a function block 2408 to determine the minimum distance (d) from (Xₚ, Yₚ)ₜ to one of the other four coordinates (X₁, Y₁)ₜ, (X₁, Y₂)ₜ, (X₂, Y₁)ₜ, and (X₂, Y₂)ₜ. The program then flows to a return block 2410.

Referring now to FIG. 24A, there is illustrated a diagrammatic view of one path of traversal on the touch screen 104. This is illustrated with a stored history of five coordinate locations for a time “t,” “t−1,” “t−2,” “t−3,” and “t−4.” Since these are coordinates, the distance between the five coordinates can be determined in addition to the angle therebetween. Thus, not only can a general direction be determined to the next coordinate location but, also, the angular deviation thereof can be determined and even the magnitude of the change. Any type of curve fitting algorithm could be utilized to make such a prediction. This, of course, is a more sophisticated processing operation, which would require more processing time by the CPU. This may be undesirable from a power standpoint or a time standpoint. However, utilizing a more sophisticated prediction algorithm might allow a fully predictive finger tracking algorithm to be utilized.

It will be appreciated by those skilled in the art having the benefit of this disclosure that this touch screen scanning and finger tracking algorithm provides an improved process for scanning a capacitive array. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A method for tracking the paths of multiple objects across the surface of a capacitive touch screen using capacitive sensing of rows and columns therefore, comprising the steps of:
storing historical information for the coordinate location of a first object;
determining with a first determining step the potential coordinate location for both the first object and a second object at a current and given time; and
determining with a second determining step which of the potential coordinate locations is associated with the first object at the given time based on the stored historical information.

2. The method of claim 1, wherein the multiple objects are fingers.

3. The method of claim 1, wherein the historical information comprises at least a last known coordinate location at a prior time to the current and given time and wherein the second determining step comprises the steps of:
accessing the historical information which comprises the last known coordinate location of the first object;
determining the distance between the last known coordinate location of the first object and each of the determined potential coordinate locations of the first object;
selecting the one of the determined potential coordinate locations having the minimum distance to the last known coordinate location as the current coordinate location for the first object at the current and given time; and
storing the one of the determined potential coordinate locations determined as the current coordinate location for the first object as the last known coordinate location for a future determining step.

4. The method of claim 1, wherein the second step of determining comprises the steps of:
predicting with the historical information a predicted location of the first object at the current and given time;
determining the distance between the predicted location and each of the determined potential coordinate locations;
selecting the one of the determined potential coordinate locations having a minimum distance to the predicted coordinate location as the current coordinate location for the first object; and
storing the one of the determined potential coordinate locations determined as the current coordinate location as the historical information for the first object for a future step of determining.

5. The method of claim 4, wherein the historical information contains at least the last known location for the first object and a previous coordinate location prior to the last known location.

6. The method of claim 5, wherein the step of predicting comprises:
determining direction from the last known location to a potential new coordinate location at the given and current time; and
determining a distance based on the last known location and the previous coordinate location to define the distance of the predicted coordinate location from the last known coordinate location.

7. The method of claim 1, wherein the historical information includes at least a last known coordinate location of the first object and a previous location of the last known coordinate location prior in time to the last known coordinate location and wherein the second determining step comprises determining which of the potential coordinate locations is associated with the first object based on one of the last known coordinate location or upon the last known coordinate location and the oldest last known coordinate location.

8. The method of claim 7, wherein the second step of determining is based upon the last known location only or upon the combination of the last known location and the oldest known location based upon the first step of determining that the at least one axis of the determined potential coordinate locations is substantially similar.

9. A method for tracking paths of multiple finger touches across a surface of a capacitive touch screen using capacitive sensing of rows and columns therefore, comprising the steps of:
storing historical information for the x-y coordinate location of a first finger touch at a prior point in time relative to the current time;
determining with a first determining step x-y coordinates representing the x-coordinates intersecting with the first finger touch and a second finger touch and the y-coordinates intersecting with the first finger touch and the second finger touch;
determining with a second determining step which of the determined x-coordinates and which of the determined y-coordinates are associated with the first finger touch representing the current x-y coordinate position of the first finger touch on the touch screen at the current time such that the x-y coordinate position of the second finger touch can be determined to be x-y coordinate position comprised of at least the one of the determined x-coordinate or determined y-coordinate that does not comprise the x- and y-coordinate of the x-y coordinate position of the determined current position of the first finger touch; and
storing in place of the historical information at least in a portion thereof the determined x-y coordinate position of the first finger touch at the current time for use in a future determining step.

10. The method of claim 9, wherein the first step of determining determines potential x-y coordinate positions of the first finger touch and the second finger touch on the touch screen and wherein the second step of determining comprises the step of determining the minimum distance to one of the determined potential x-y coordinate positions of the first finger touch and the second finger touch and either, in one mode, the stored x-y coordinate position comprising the historical information or, in a second mode, a predicted x-y coordinate position of the first finger touch at the current time, in which the one of the determined x-y coordinate positions determined to be at the minimum distance comprises the current coordinate position of the first finger touch, wherein the predicted x-y coordinate position is based on the stored historical information.

11. The method of claim 10, wherein the first or second mode is selected based on the proximity of the either the determined x-coordinates in the second step of determining to each other or the proximity of the either the determined y-coordinates in the second step of determining to each other.

12. The method of claim 11, wherein the second mode is selected when the determined x-coordinates or y-coordinates, respectively, are proximate each other.

13. The method of claim 10, wherein the historical information comprises at least a last known x-y coordinate position at the prior time to the current time and wherein the second step of determining in the second mode of operation comprises steps of:
accessing the historical information which comprises the last known x-y coordinate position of the first finger touch;
determining the distance between the last known x-y coordinate position of the first finger touch and each of the potential x-y coordinate positions; and
selecting one of the determined potential x-y coordinate positions having the minimum distance to the last known x-y coordinate position as the current x-y coordinate position of the first finger touch at the current time.

14. The method of claim 10, wherein the second step of determining in the second mode of operation comprises the steps of:
predicting with the historical information a predicted location of the first finger touch at the current time;
determining the distance between the predicted location and each of the determined potential x-y coordinate positions; and
selecting the one of the determined potential x-y coordinate positions having a minimum distance to the predicted x-y coordinate position as the current x-y coordinate position of the first finger touch.

15. The method of claim 14, wherein the historical information contains at least the last known x-y coordinate position for the first finger touch and a previous x-y coordinate position prior to the last known x-y coordinate position.

16. The method of claim 15, wherein step of predicting to provide the predicted x-y coordinate position comprises the steps of:
determining direction from the last known x-y coordinate position to a predicted new x-y coordinate position at the current time; and
determining distance based on the last known x-y coordinate position and the previous x-y coordinate position to define the distance of a predicted x-y coordinate position from the last known x-y coordinate position.

17. An touch screen device for tracking finger movement over a surface, comprising:
a touch screen having rows and columns;
a touch detector for detecting at which row and column of the touch screen a finger touch has occurred at a current time, and wherein multiple touches of at least first and second fingers at substantially the same time could result in finger touch ghosts such that an ambiguity exists as to which of the x- and y-coordinates at which a finger touch was detected is associated with at least the first finger such that multiple potential x-y coordinate positions exist for the first finger;
a memory for storing historical information of the x-y coordinate position of a finger touch of the first finger on the touch screen; and
a processor for analyzing the potential x-y coordinate positions as a function of the stored historical information and determining which is the correct x-y coordinate position as the current x-y coordinate position of the finger touch associated with the first finger at the current time, the processor storing the determined current x-y coordinate position in the memory as historical information for a future determination of the current x-y coordinate position.

18. The device of claim 17, wherein the memory stores a last known x-y coordinate position of the finger touch of the first finger and the processor is operable to determine the distance to each of the potential x-y coordinate positions from the stored last know x-y coordinate position and select the one thereof with the minimum distance as the current x-y coordinate position of the finger touch associated with the first finger.

19. The device of claim 17, wherein the memory stores a last known x-y coordinate position and an older x-y coordinate position relative thereto of the finger touch of the first finger and the processor includes a prediction engine that is operable to predict where the finger touch associated with the first finger will occur as a predicted x-y coordinate position based upon the last known x-y coordinate position and the older x-y coordinate position, and wherein the processor determines the distance to each of the potential x-y coordinate positions from the predicted x-y coordinate position and select the one thereof with the minimum distance as the current x-y coordinate position of the finger touch associated with the first finger.
